(19) United States
(12) Patent Application Publication
(10) Pub. No.: US 2018/0147611 A1
(43) Pub. Date: May 31, 2018

(54) Apparatus, System and Method for Cleaning Inner Surfaces of Tubing

(71) Applicant: 1863815 Ontario Limited, Point Edward (CA)

(72) Inventor: Glenn L. CARSON, Point Edward (CA)

(73) Assignee: 1863815 Ontario Limited, Point Edward (CA)

(21) Appl. No.: 15/822,787

(22) Filed: Nov. 27, 2017

Related U.S. Application Data
(60) Provisional application No. 62/427,366, filed on Nov. 29, 2016.
(60) Provisional application No. 62/447,673, filed on Jan. 18, 2017.

(51) Int. Cl. B08B 3/12; F28G 7/00; B08B 9/032; F28G 9/00

(52) U.S. Cl. CPC B08B 3/12; F28G 7/00; B08B 2209/005; F28G 9/00; B08B 9/0326

(57) ABSTRACT

Cleaning the inside surfaces of tubes in a cracking furnace, or other type of structure with tubes, is very difficult and time consuming. An acoustic energy cleaning apparatus is provided that is clamped onto a tube, and a liquid solvent is filled within the tube. The cleaning apparatus includes an ultrasonic transducer that causes cavitation of the liquid inside the tube, which dislodges material build-up. The apparatus also includes a rigid seal cover that encompasses a lower portion of a transducer housing, and an annular resilient seal positioned within and below the seal cover. The apparatus also includes an injection hole that fluidly connects a space, defined at least by the annular resilient seal and a bottom surface of the acoustic transducer, to an external environment. A user injects gel into the injection hole.

### CROSS-REFERENCE TO RELATED APPLICATIONS

This patent application claims priority to U.S. Patent Application No. 62/427,366, titled “Acoustic Transducer Apparatus, System and Method for Cleaning Inner Surfaces of Tubing”, and filed on Nov. 29, 2016, and to U.S. Patent Application No. 62/447,673, titled “Apparatus, System and Method for Cleaning Inner Surfaces of Tubing”, and filed on Jan. 18, 2017, the entire contents of which are herein incorporated by reference.

### TECHNICAL FIELD

The following generally relates to cleaning inner surfaces of tubing.

### BACKGROUND

In the field of heater exchangers and chemical reactors, tubing is often used. For example, in cracking furnaces and heater exchangers, there are parallel tubes connected to each other at their ends using bends, such as U-bends or other types of bends, to form a continuous tube. Fluid typically flows through the piping while the chamber or environment around the piping is heated to heat the fluid flowing within the piping.

In a tubular reactor for cracking, a furnace houses banks of tubes that are connected to each other to form one or more continuous tubes for fluid to flow through. The tubes may form a serpentine configuration. Furnace guns or heat generators, for example, surround the banks of tubes.

The straight parallel portions of the tubing are typically positioned close together to reduce the amount of space being used within the furnace or the heat exchanger. There may be dozens to hundreds of straight portions of tubes. The inner diameter of the tubes typically range from under one inch to several inches.

The cracking process results in deposits, scales, product or by-product build-up, and material in general to collect on the inner surfaces of the tubes. This reduces the flow of fluid within the tubes, as well as the efficiency of the cracking process.

Cleaning the tubes in the furnace is costly, typically requires a lot of manual labour and large machinery, and typically requires an extended amount of time during which the cracking furnace is shut down.

To clean the surfaces of an object, ultrasonic acoustic waves acting on a fluid in contact with the surface can provide enough energy to remove unwanted product build-up. This fluid undergoes cavitation through the use of ultrasonic transducers. The forces caused by cavitation combined with cleaning chemicals present in the fluid work to dislodge the layers of built-up deposits.

U.S. Pat. No. 4,120,699 describes multiple transducers are placed around a jacket that contains therein a tube bank, and which is immersed in fluid. The transducers are not directly mounted to a given tube within the bundle.

U.S. Pat. No. 6,290,778 describes a heat exchanger cleaning device for tube-in-shell heat exchangers. An ultrasonic transducer probe array, which is positioned at the end of a cable, is inserted inside a fluid filled shell and swept along the interior tubes producing acoustic waves causing cavitation of the fluid for cleaning. This requires access to the interior of a tube, which can have many bends, such as U-bends, that may cause the probe to become lodged.

U.S. Pat. Nos. 7,500,402 and 3,987,674 each describe an ultrasonic transducer measuring device that are to be positioned on a pipe. The transducer energy and operation settings are used for sensing, and not for cleaning.

U.S. Pat. No. 4,244,749 describes parallel spaced apart banks of pipes each having external surfaces exposed to a liquid environment, such as in bath vessel. An ultrasonic cleaning array is dipped into the bath, in a space between the pipes, and then activated to cause cavitation of the liquid. The transducers are not mounted directly to a tube.

### SUMMARY OF THE INVENTION

Examples embodiments of the invention are provided below, including example aspects of such embodiments. Additional features of the embodiments as well as additional example embodiments are described in the figures and the detailed description.

A cleaning system for cleaning tubes is provided. For example, the system includes: a string of multiple cleaning apparatuses in electrical communication with each other and configured to be mounted along a length of a tube; a primary control module that is in electrical connection with a first cleaning apparatus in the string of multiple cleaning apparatuses; each one of the cleaning apparatuses comprising an acoustic transducer, a releasable clamping mechanism to mount the transducer to the tube, and a microcontroller to control the transducer; and wherein the microcontroller is configured to receive a data command from the primary control module.

A method for cleaning a tube, or multiple tubes, in a furnace is provided. The method, for example, includes: filling the tube in the furnace with a liquid solvent; mechanically cleaning multiple portions an exterior surface of the tube, the multiple portions space apart from each other along a length of the tube; clamping multiple cleaning apparatuses on to the cleaned multiple portions of the tube, each of the cleaning apparatuses comprising an acoustic transducer; activating the cleaning apparatuses via a primary control module that is in electrical communication with the cleaning apparatuses; deactivating the cleaning apparatuses; flushing the tube with new liquid solvent; and removing the cleaning apparatuses from the tube.

An acoustic energy cleaning apparatus is provided for cleaning an interior surface of a tube. For example, the apparatus includes: a transducer housing that houses an acoustic transducer; a rigid seal cover that encompasses a lower portion of the transducer housing; an annular resilient seal positioned within and below the seal cover; and an injection hole that fluidly connects a space, defined at least by the annular resilient seal and a bottom surface of the acoustic transducer, to an external environment, the injection hole having an opening to receive an injection of gel.

A cleaning system for a tube is provided and it includes: the tube comprising a mechanical receiver positioned at an opening in a wall of the tube; a removable plug that can be mechanically fastened and removed from the mechanical receiver; a cleaning apparatus that can be mechanically fastened to the mechanical receiver in place of the removable plug, and can be subsequently removed from the mechanical receiver; the cleaning apparatus comprising an electromechanical device to at least one of vibrate the wall of the tube and excite liquid within the tube; and a wire extending from the cleaning apparatus to provide electric power to the electromechanical device.

### BRIEF DESCRIPTION OF THE DRAWINGS

Embodiments will now be described by way of example only with reference to the appended drawings wherein:

FIG. 1A is a schematic diagram of an example cleaning system for inner surfaces of tubing, showing a partial cut-away of an enclosure and revealing the tubing within the enclosure.

FIG. 1B is a schematic diagram of another example cleaning system for inner surfaces of tubing, showing a partial cut-away of an enclosure and revealing the tubing within the enclosure.

FIG. 2 is a schematic drawing of a system of cleaning apparatuses that are connected in a series.

FIG. 3 is a systems diagram showing the system of cleaning apparatuses in electrical connection with a primary control module.

FIG. 4A is an isolated view of an example embodiment of a given cleaning apparatus that uses an expanding seal, showing a cross-section of the component before the seal is expanded, the strap mechanism and the tube requiring cleaning. FIG. 4B shows the given cleaning apparatus in a compressed state with the expanded seal.

FIG. 5 is a cross section of an example embodiment of a cleaning apparatus with an expandable seal and an injection hole and weep hole, that are in fluidic communication with a space between the tube and a surface of the transducer.

FIG. 6A is an isolated view of an example embodiment of a given cleaning apparatus that uses an inflatable seal, showing a cross-section of the component before the seal is inflated. FIG. 6B shows the given cleaning apparatus in a compressed state with the inflated seal.

FIG. 7A is an isolated view of an example embodiment of a given cleaning apparatus that uses a compressible seal, showing a cross-section of the component before the seal is compressed. FIG. 7B shows the given cleaning apparatus with the seal in a compressed state.

FIG. 8A is an isolated view of an example embodiment of a given cleaning apparatus that uses another example of a compressible seal, showing a cross-section of the component before the seal is compressed. FIG. 8B shows the given cleaning apparatus with the seal in a compressed state.

FIG. 9A is an isolated view of an example embodiment of a given cleaning apparatus that uses another example of a compressible seal, showing a cross-section of the component before the seal is compressed. FIG. 9B shows the given cleaning apparatus with the seal in a compressed state.

FIG. 10A is an isolated view of an example embodiment of a given cleaning apparatus that uses another example of a compressible seal, showing a cross-section of the component before the seal is compressed. FIG. 10B shows the given cleaning apparatus with the seal in a compressed state.

FIG. 11 is a perspective view of an example embodiment of an annular compression plate that acts on a compressible seal.

FIG. 12 is a perspective view of an example embodiment of the compressible seal.

FIG. 13 is a cross-section view of an example embodiment of a cleaning apparatus mounted to a tube, which includes bottom surface of a transducer that is curved to substantially match the outer curved surface of a tube.

FIG. 14A is an isolated view of an example embodiment of a given cleaning apparatus that uses another example of a gel pouch that acts as a compressible seal, showing a cross-section of the component before the pouch is compressed. FIG. 14B shows the given cleaning apparatus with the pouch in a compressed state.

FIG. 15 is a side-view of a gel-injection device.

FIG. 16 shows a series of cleaning apparatuses mounted to a pipe, and different types of the cleaning apparatuses are arranged in an alternating pattern within the series.

FIG. 17 is a flow diagram of an example method for using the cleaning system to clean tubes.

FIGS. 18A, 18B and 18C are different views of a section of tube with a removable plug.

FIG. 19 is a cross-section view of a tube, similar to FIG. 18B, but with a cleaning apparatus positioned within the tube.

FIG. 20 is a cross-section view of the tube shown in FIG. 18B, but with a cleaning apparatus positioned within the tube.

FIGS. 21A, 21B and 21C are different views of a section of tube with a removable plug.

FIG. 22 is a perspective view of the tube shown in FIG. 21A, but with a cleaning apparatus positioned within the tube.

FIG. 23 is a cross-section view of the tube shown in FIG. 21B, but with a cleaning apparatus positioned within the tube.

FIG. 24 is a cross-section view of the tube shown in FIG. 21B, but with a cleaning apparatus positioned within the tube.

FIGS. 25A and 25B are different views of a section of tube with a removable plug.

FIG. 26 is a cross-section view of the tube shown in FIG. 25A, but with a cleaning apparatus positioned within the tube.

FIG. 27 is a cross-section view of the tube shown in FIG. 25A, but with a cleaning apparatus positioned within the tube.

FIGS. 28A, 28B, 28C and 28D are different views of a section of tube with a removable plug.

FIG. 29 is a cross-section view of the tube shown in FIG. 28C, but with a cleaning apparatus positioned within the tube.

FIG. 30 is a cross-section view of the tube shown in FIG. 28C, but with a cleaning apparatus positioned within the tube.

FIG. 31 is a cross-sectional view of a bend portion of a tube within a furnace enclosure, and further showing a cross-section of a wall of the enclosure.

FIG. 32 is a cross-sectional view of a removable bend portion of a tube, with the removable bend portion including a cleaning apparatus, according to another example embodiment.

FIG. 33 is a perspective view of the removable bend portion of the tube with the embedded cleaning apparatus shown in the example embodiment of FIG. 32.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It is herein recognized that cleaning the inner surface of tubing in cracking furnaces and heat exchangers is difficult due to limited access, the long length of tubing, and the multiple U-bends connecting straight segments of the tubing.

Existing cleaning systems use a cleansing bath method wherein tube sections are removed and submerged into a large vessel that contains cleaning fluid. In particular, tube sections are removed from a cracking furnace and are transported to a facility that holds the large vessel. The tube sections are then submerged within the vessel, and the fluid is made to undergo cavitation by acoustic waves from ultrasonic transducers. The cavitation effect applies pressure to the tubes, dislodging built-up deposits. The treated tube sections are then transported back to the cracking furnace to be re-installed. It is herein recognized, however, that the removal, transportation, and re-installation of the tube sections requires manual effort and increases the amount of time that the cracking furnace is inoperable. Furthermore, a large amount of electrical energy is required to agitate the large amount of fluid within the vessel.

It is also recognized that some cleaning systems use ultrasonic transducers, but these transducers are not mounted directly to a tube. This separation and distance will therefore increase the amount of energy required to clean a tube.

Furthermore, while sensor-type transducers are used for measurement, these transducers are typically lower power and are not configured for cleaning.

It is also herein recognized that tubes come in many different diameters, and that a tube may not be perfectly cylindrical. Therefore, having a cleaning system that is adaptable to the variances in tube surfaces is desirable, while still maintaining a high transfer of acoustic energy from the transducer to the tube.

It is also desirable to reduce the setup and the manual effort of a process required to clean tubing. This reduced setup includes, for example, using a reduced amount of liquid to excite.

The proposed example cleaning apparatuses, systems and methods address one or more of the above issues.

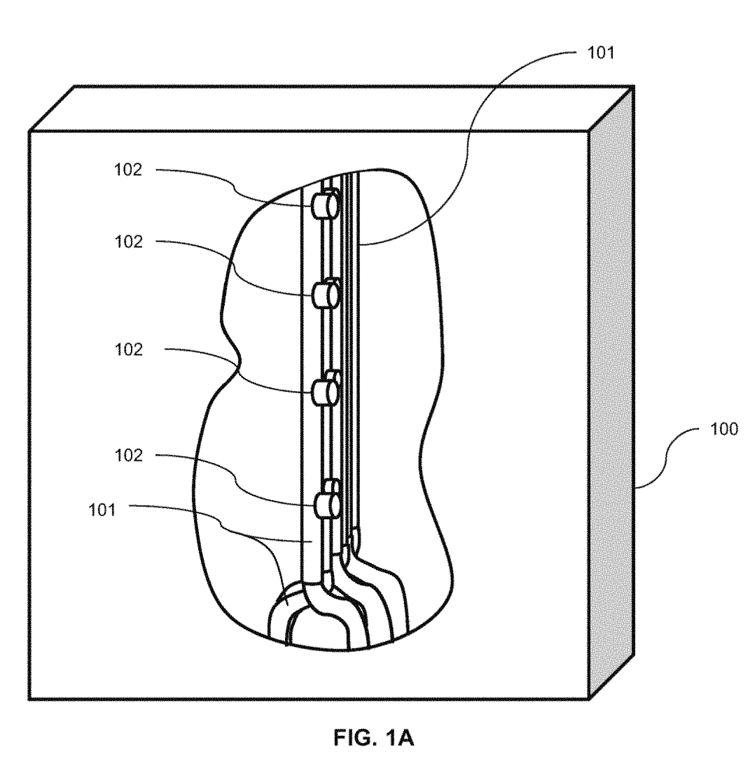

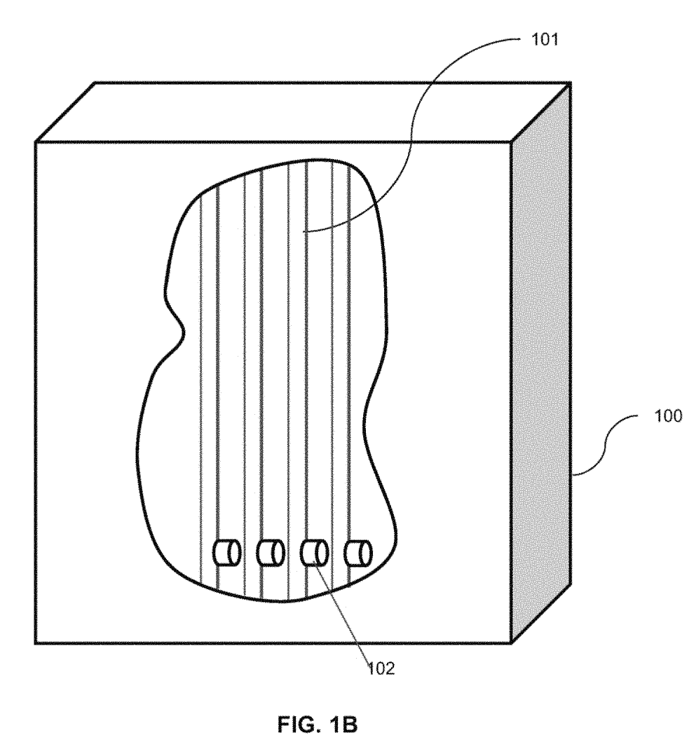

Turning to FIG. 1A, an example embodiment of a furnace 100 is shown. A partial cut-away illustrates that the enclosure of the furnace contains a number of tubes 101 with cleaning apparatuses 102 attached along the length of the tubes. In many furnaces, the tubes are vertically oriented. However, the cleaning apparatuses may also be placed on tubes that are oriented differently (e.g. horizontally, on slants, etc.). One or multiple cleaning apparatuses may be positioned along the length of a tube.

The furnace, for example, is a hydrocracking furnace, a steam cracking furnace, a gas cracking furnace, or a liquid cracking furnace. Other types of currently known or future known cracking furnaces are applicable. It is appreciated that, while many of the examples described herein relate to furnaces, the features described herein are also applicable to other structures that have tubing. For example, a heat exchanger having tubing can benefit from the systems and methods proposed herein.

In an example embodiment, each cleaning apparatus 102 is removable and attachable to the tube.

For example, the cleaning apparatus 102 is attachable to the exterior of surface of the tube.

In another example, the cleaning apparatus 102 is inserted into a receiver on a tube. The receiver is positioned at an opening in the tube wall and the cleaning apparatus can be inserted at or within the opening, so that the cleaning apparatus is in fluidic communication with the interior of the tube.

In an example embodiment, each cleaning apparatus includes one or more ultrasonic transducers.

In an alternative example embodiment, each cleaning apparatus includes at least one of a sonic transducer an ultrasonic transducer. For example, in a cleaning system that includes a series of cleaning apparatuses, every other apparatus includes an ultrasonic transducer and every other apparatus includes a sonic transducer.

The ultrasonic transducers are powered and operated at frequency settings to cause cavitation of the liquid within the tube.

In an example embodiment, the sonic transducers include sound emitters for audible sound in the approximate frequency range 20-20,000 Hz. In another example, the sonic transducers are devices, e.g. pulsators, that emit non-audible sound, infrasound, in the approximate frequency range 2-20 Hz. In an example embodiment, the sonic transducers emit acoustic energy at frequencies in the range extending from 60 to 800 Hz.

In another example embodiment the cleaning apparatus 102 is a mechanical device or an electromechanical device that produces vibrations. This type of device is also known as a vibrator. For example, an electric motor or an electric actuator, or a combination of both, are used to generate vibrations. The vibrations are used to loosen and dislodge the build-up of material on the inner surface of a tube. The vibrations are, for example, emitted to vibrate the tube wall itself, or the liquid within the tube, or both.

It another example embodiment, the cleaning apparatus 102 includes a combination of a vibrator and an acoustic transducer (e.g. a sonic transducer or an ultrasonic transducer).

In addition or in an alternative example embodiment, the cleaning apparatus 102 includes a heating element to assist with the cleaning process.

In addition or in an alternative example embodiment, the cleaning apparatus 102 includes a light source to emit light for the purposes of cleaning. For example, the light source shines ultraviolet (UV) light to aid in the cleaning process.

Turning to FIG. 1B, in another example embodiment, each vertical segment of a tube 101 has one cleaning apparatus 102. The vertical segments of a tube may or may not be connected using joints (e.g. such as U-bends). In an example embodiment, a single cleaning apparatus is able to agitate the tube itself, or the liquid within the tube, or both, to clean a given vertical segment of a tube. In another example aspect, the cleaning apparatus is positioned at a lower portion of a given vertical segment of a tube. The bubbles in the liquid produced by the cleaning apparatus rise upwards within the tube, cleaning the interior surface of the tube along the way.

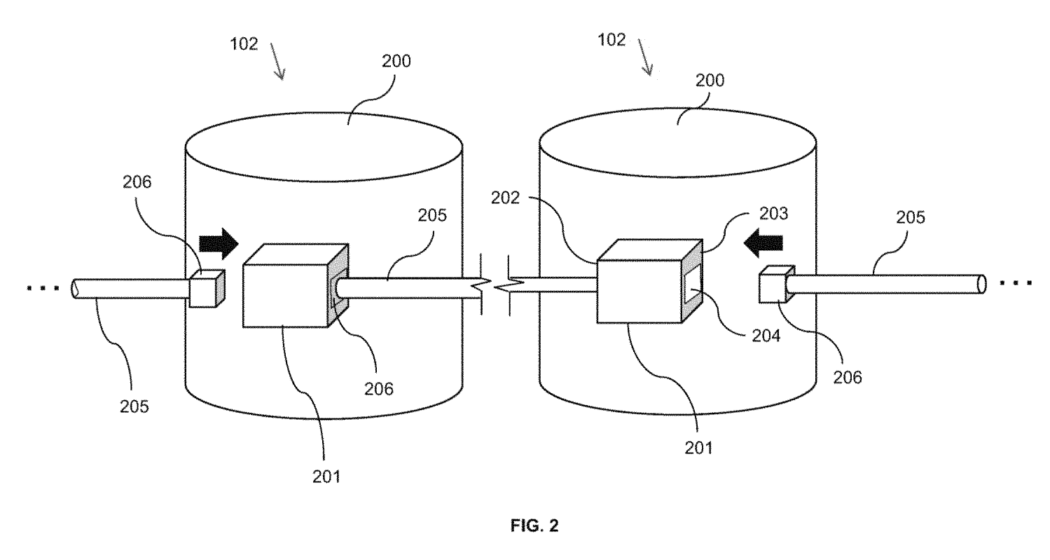

As shown by FIG. 2, an example embodiment shows multiple cleaning apparatuses 102 electrically connected to each other. Each apparatus 102 includes a transducer housing 200 that houses a transducer. The transducer converts electrical energy into acoustic energy (e.g. at an ultrasonic frequency or at a sonic frequency). As part of, or fixed on to, the housing 200 is a microcontroller housing 201, which houses a microcontroller. The microcontroller housing 201, in the example of FIG. 2, protrudes from the transducer housing 200. However, in another example, the transducer housing and the microcontroller housing are incorporated into a unitary body.

The microcontroller housing 201 includes two electrical connection receptacles 204 to electrically connect one cleaning apparatus 102 to another cleaning apparatus 102. In particular, an electrical wire 205 has at both ends connectors 206. A given connector 206 can be inserted into a given receptacle 204.

In an example embodiment, the microcontroller housing 201 has side surfaces 202 and 203 that are at opposite ends from each other, and each of the side surfaces 202 and 203 have defined therein a receptacle 204.

The microcontroller can be programmed to activate a transducer at a desired time, or at a desired pattern, or both. The microcontroller is also programmable to control the frequency at which the transducer emits acoustic energy.

The electrical wire 205 is used to transmit electrical energy to power each of the cleaning apparatuses that are interconnected, and to also transmit control signals. For example, the control signals synchronize the operation of the cleaning apparatuses.

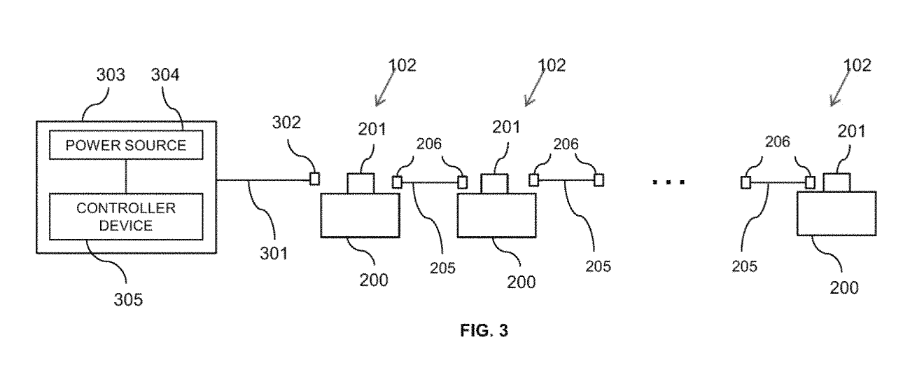

FIG. 3 shows a system diagram that illustrates the electronic connection and control of a tube cleaning system. A primary control module 303 is electrically connected, via an electrical wire 301 with an end connector 302, to a cleaning apparatus 102 that is a first one in a series of cleaning apparatuses 102. In operation, the cleaning apparatuses 102 are electrically connected to each other using the wires 205 to form the series. It will be appreciated that the end connectors 206 of the wires 205 are shown disconnected from the receptacles of the microcontroller housing 201 to show how the cleaning system is setup. However, in operation, the end connectors 206 are connected to the receptacles.

The primary control module 303 includes a power source 304 and a controller device 305. The power source 304 outputs electrical power that is transmitted via the wires to each of the cleaning apparatuses in the series. The controller device 305 outputs commands that determines the operation of the power source 304. The controller device 305 also outputs commands that are receivable by the microcontroller of each cleaning apparatus and, in turn, the microcontroller uses the received command to affect its operating attributes (e.g. pattern or timing of operation, frequency output, etc.).

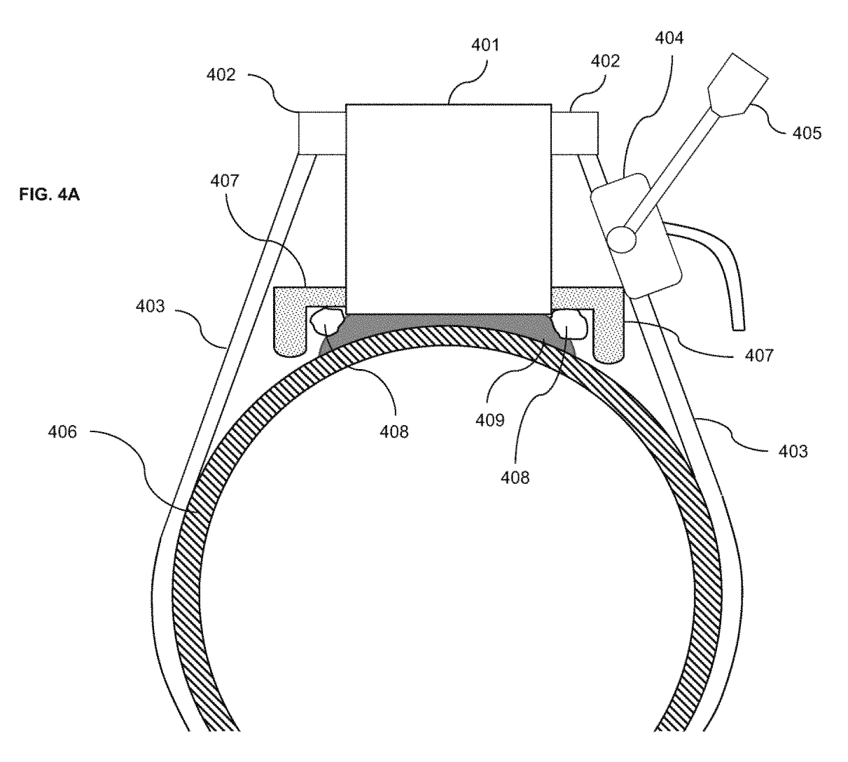

Turning to FIGS. 4A and 4B, an example embodiment of a cleaning apparatus is shown mounted to a tube 406 in an uncompressed or partially compressed state (see FIG. 4A) and in a compressed stated (see FIG. 4B).

The tube 406 and elements of sealing components 407, 408 and 409 are shown in a cross-sectional view. The sealing components are used to ensure that there are little or no air gaps through which the acoustic waves to dissipate. In particular, if the acoustic waves generated by a transducer pass through air, then the acoustic energy being transmitted into a tube body and into the liquid inside the tube is drastically diminished. In other words, there is a loss of energy due to an air gap, which reduces the effectiveness of the cleaning apparatus. To improve the transfer of energy from an ultrasonic transducer, or a transducer, or both to the tube wall, then various types of sealing components are herein proposed.

FIG. 4A shows a cross-sectional view of a cleaning apparatus. The cleaning apparatus includes a transducer 401 (e.g. an ultrasonic transducer or a sonic transducer), a latching component 402 attached to the transducer, and a strap 403 attached to the latching component. The strap feeds through a ratchet clamp mechanism 404, controlled by a ratchet lever 405. The ratchet clamp mechanism, upon using the ratchet lever, tightens the strap around a tube 406.

It will be appreciated that other types of clamping mechanisms may be used with the cleaning apparatuses described herein. For example, thread bolts, friction belts, and other devices may be used to mechanically secure the cleaning apparatus to the tube, while still allowing the cleaning apparatus to be removed after the cleaning operations are performed.

The lower portion of the transducer is encompassed by a rigid seal cover 407. The rigid seal cover protrudes outwards from the sides of the transducer, and extends downwards to define within a cavity, which holds an expandable seal 408. In particular, the expandable seal 408 is positioned around the perimeter of the lower portion of the transducer 401.

Positioned between the tube 406 and the bottom surface of the transducer is a gel 409, which transmits the acoustic energy from the transducer to the tube 406. The seal 408 helps to trap the gel 409 from leaking, so that over time, the gel remain in place. The gel is also known as an ultrasonic gel, or a coupling agent.

As shown in FIG. 4B, when the ratcheting clamp mechanism is used to compress and position the transducer 401 closer to the tube 406, then the expandable seal 408 compresses and expands. The expansion of the seal 408 is restrained in part by the rigid seal cover 407.

In an example operation, a user places the gel on the bottom of the transducer, within the space encircled by the expandable seal, and then places the cleaning apparatus onto the tube. Alternatively, the user places the gel on to the tube itself, and then places the cleaning apparatus on to the tube having the gel. The user then tightens the clamp, which compresses the expandable seal.

In this way, there are little or no air gaps. Furthermore, the gel remains in place over an extended period of time. It will be appreciated that the expandable seal 408 may be an O-ring that is made of a resilient polymer material.

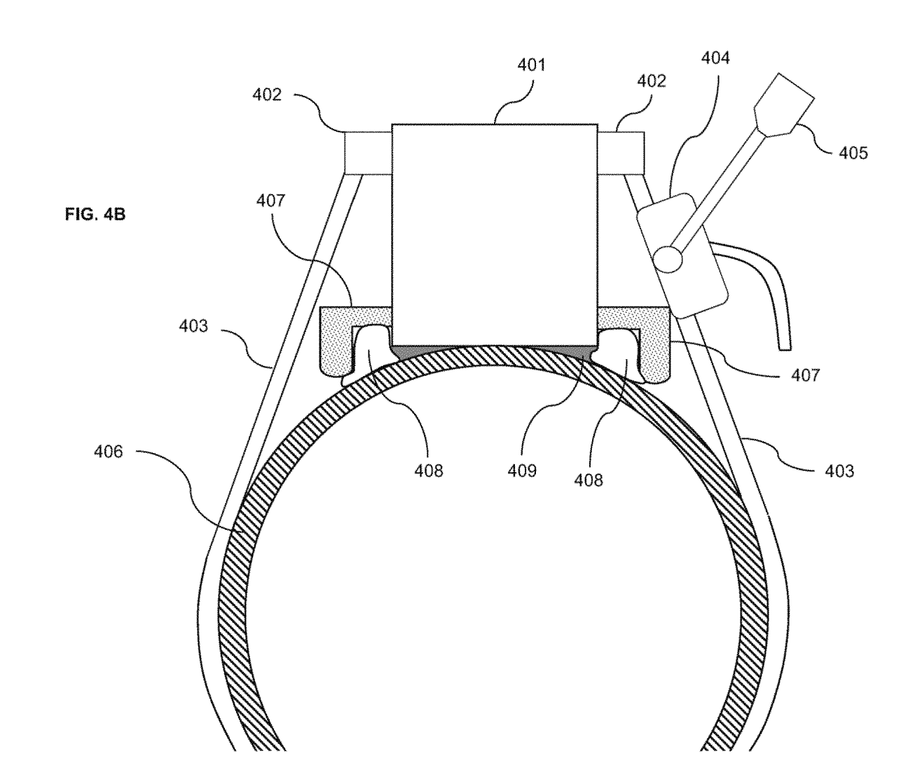

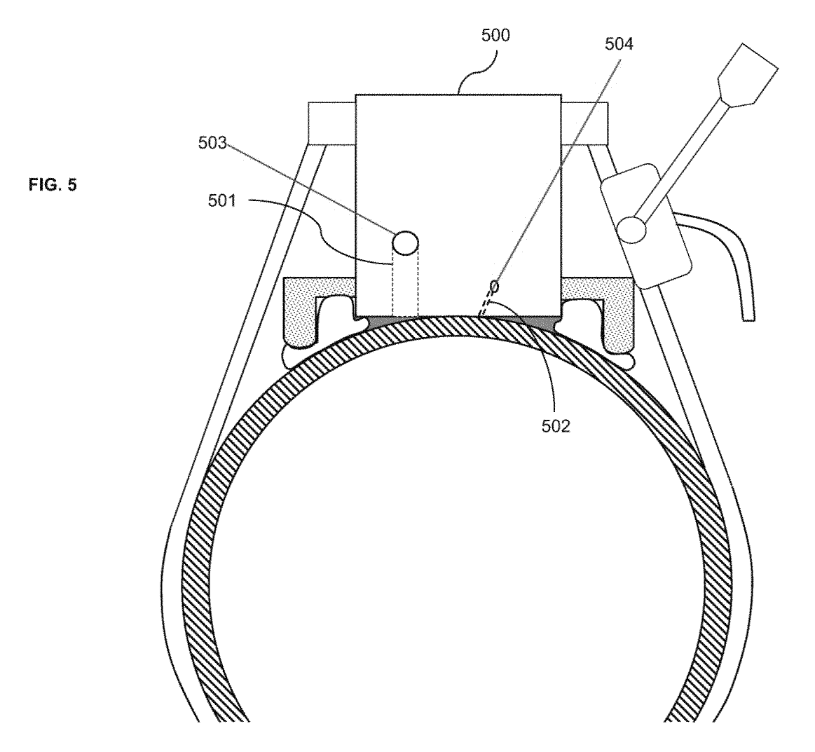

In another aspect, it is recognized that placing a sufficient amount of gel onto a vertically oriented tube can be difficult, because the gel will run down the tube due to gravity. Turning to FIG. 5, another example embodiment is shown that is similar to the cleaning apparatus in FIGS. 4A and 4B, but additionally including an injection hole 501 and weep hole 502 in the housing 500 of the transducer. In particular, after the cleaning apparatus has been strapped to the tube, the injection channel is used to inject the gel into the space defined between the transducer bottom, the expandable seal and the tube. The weep hole allows for entrapped air and excess gel to flow out. In particular, the injection hole fluidly connects an exterior environment to the space between the transducer, the seal and the tube. A user places a gel injection device (e.g. a gel gun or gel pump) into the opening 503 of the injection hole. The opening 503 is preferably covered by a cover (not shown). In an example operation, the user continues to inject the gel until gel overflows from the weep hole. After detecting this overflow, the user preferably places a cover over the opening 504 of the weep hole. It will be appreciated that the opening 504 of the weep hole is smaller than the opening 503 of the injection hole.

The embodiment shown in FIG. 5 therefore allows a user to secure the cleaning apparatus onto the tube first, followed by injecting the gel. For vertically oriented pipes, the gel is therefore contained within the desired space.

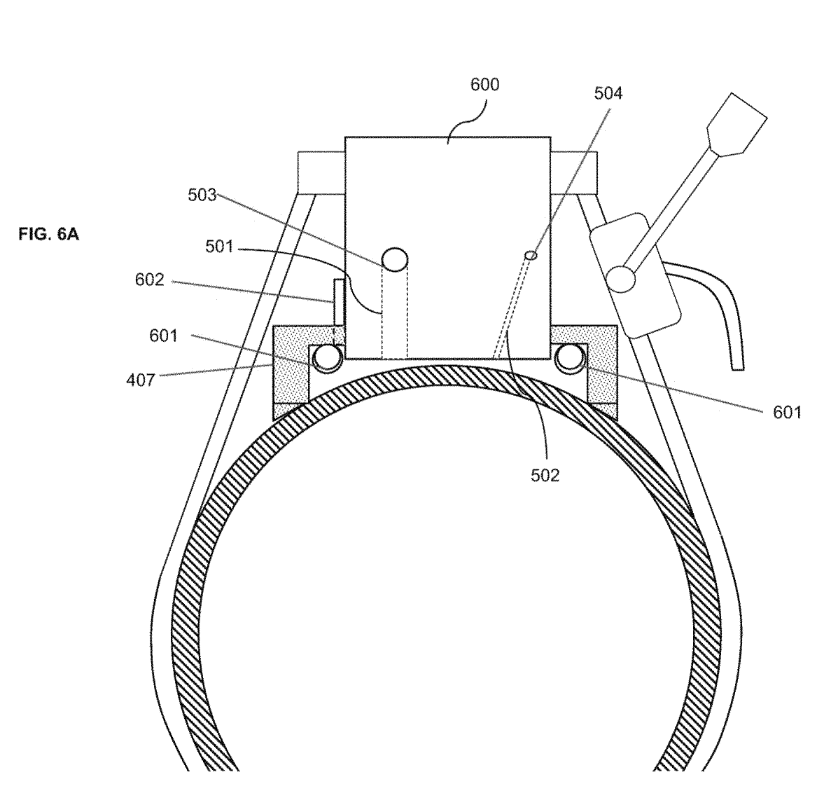

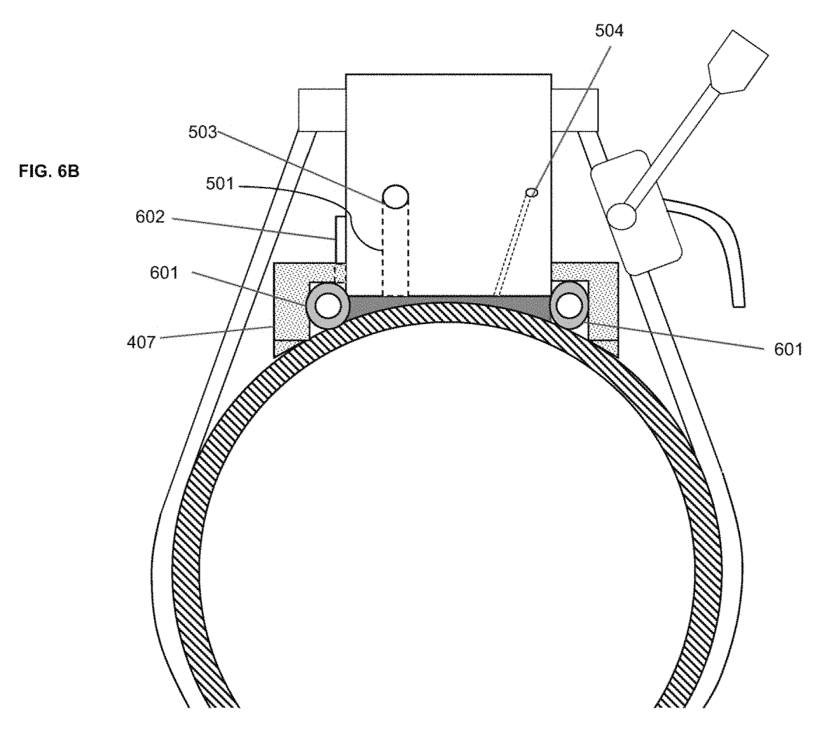

FIGS. 6A and 6B show another sealing mechanism for a cleaning apparatus comprising a transducer 600, and that includes an inflatable seal 601. In FIG. 6A, the seal 601 is not inflated and, in FIG. 6B, the seal 601 is inflated. An inflation valve 602 extends from the inflatable seal 601, and is connectable to a liquid or air source, in order to inflate the inflatable seal with liquid or air. The inflatable seal is held in position by the rigid seal cover 407. In operation, according to a preferred embodiment, the seal is inflated and then the gel is injected via the opening 503 of the injection hole 501.

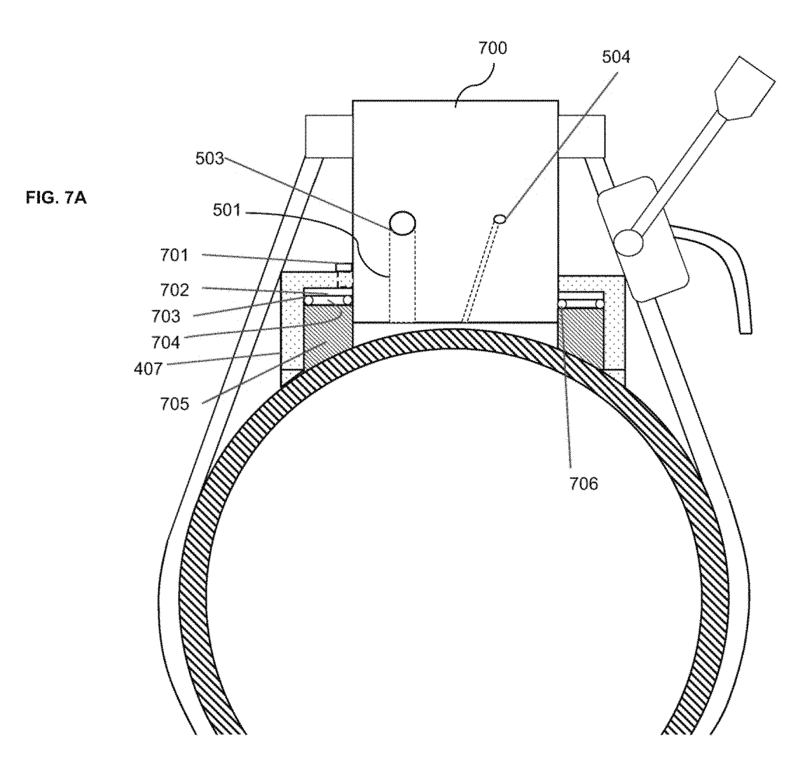

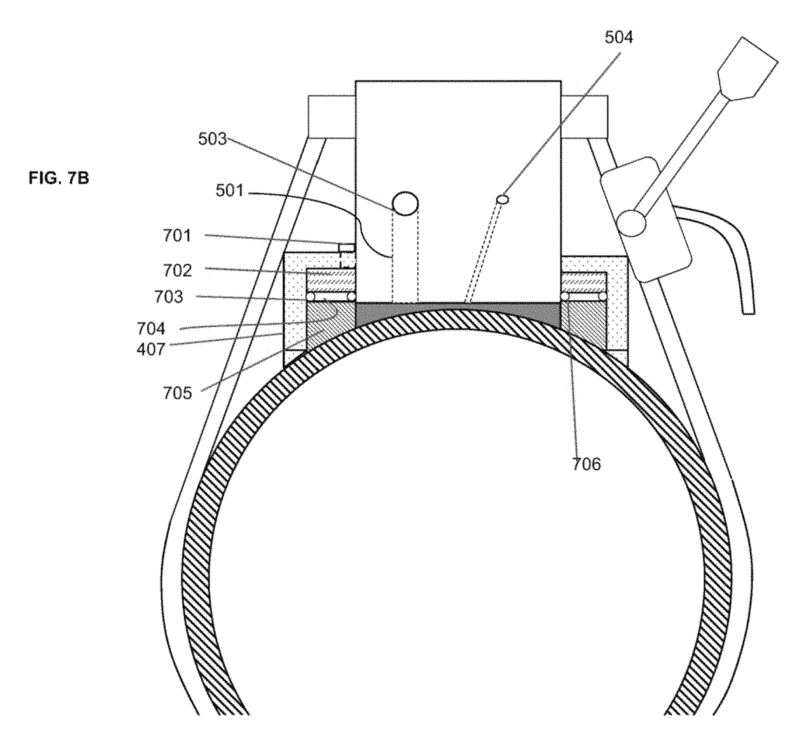

FIGS. 7A and 7B show another example embodiment of a sealing mechanism for a cleaning apparatus that includes a compressible seal 705. The compressible seal 705 surround the perimeter of the bottom of the transducer 700 and the height of the seal reduces as it is compressed. For example, the compressible seal is a ring-shaped seal made of a resilient polymer material. FIG. 7A shows the seal 705 in an uncompressed state and FIG. 7B shows the seal 705 in a compressed state.

The compressible seal 705 is positioned within the rigid seal cover 407. An annular compression plate 704 is positioned above the seal 705 to evenly distribute compression forces onto the seal 705. The plate 704 is rigid. In an example embodiment, an inner O-ring 706 and an outer O-ring 703 are placed on the inner and the outer edges of the plate 704, in order to act as a seal. In another example, the inner and out edges of the plate 704 are not surrounded by O-rings.

Above the plate 704 is space 702 that is defined by the plate, the outer wall of the transducer, and the inner walls of the rigid seal cover 407. An injection opening 701, which is in fluidic communication with the space 702, allows a user to inject a fluid into the space 702 in order to pressure the plate 704 downwards. As the plate 704 is pressed down, due to the pressure of the injected fluid, the seal 705 is compressed against the tube.

As shown in FIG. 7B, the gel has been inserted into the space, which is sealed off by the seal 705.

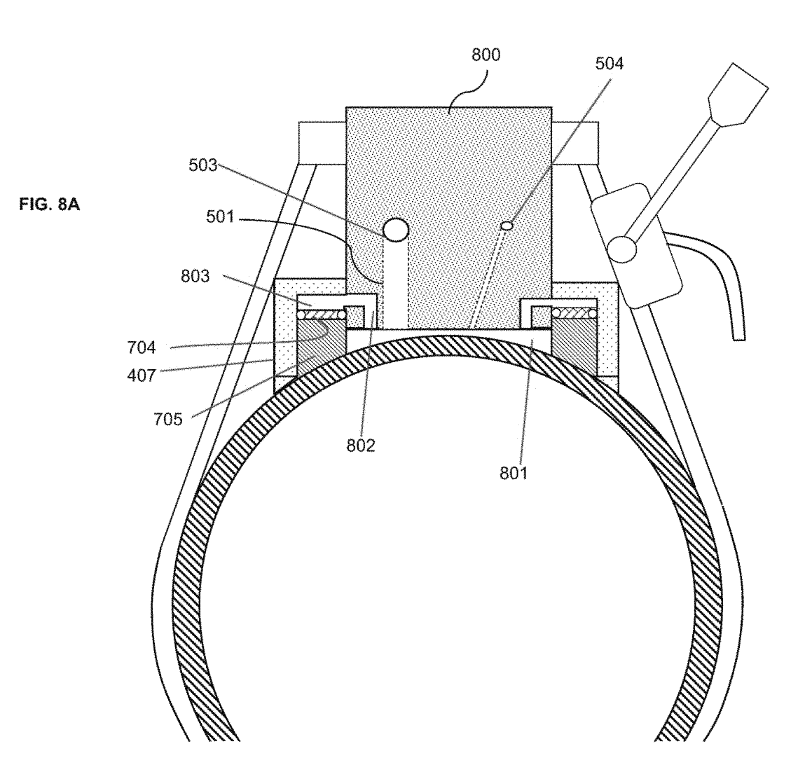

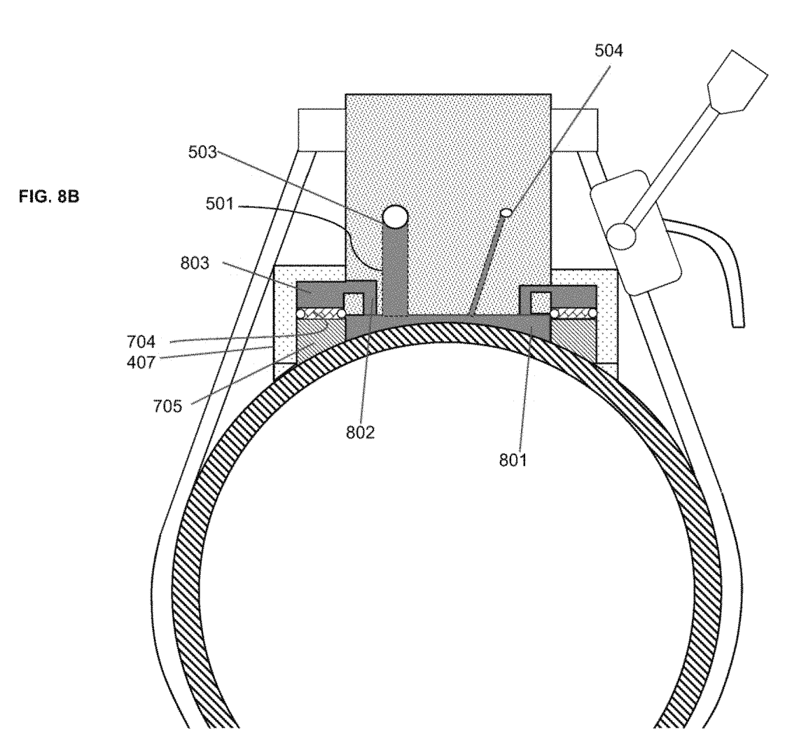

Turning to FIGS. 8A and 8B, another example embodiment of a sealing mechanism for a cleaning apparatus is shown, which includes the compressible seal 705 and the compression plate 704. Positioned above the compression plate is pressure chamber 803, which is defined by the plate, the outer wall of the transducer 800, and the inner walls of the rigid seal cover 407. The pressure chamber 803 is in fluidic communication with the space 801 defined between the tube and the bottom of the transducer, via a channel 802.

In operation, a user injects gel into the space 801 via the opening 503 of the injection hole 501. The gel travels into the space 801, into the channel 802, and then into the chamber 803. The pressure of the gel in the chamber exerts a downward pressure onto the plate 704, which in turn, presses down on, and compresses, the seal 705.

FIG. 8A shows the uncompressed state and without the gel. FIG. 8B shows the compressed state, including the gel.

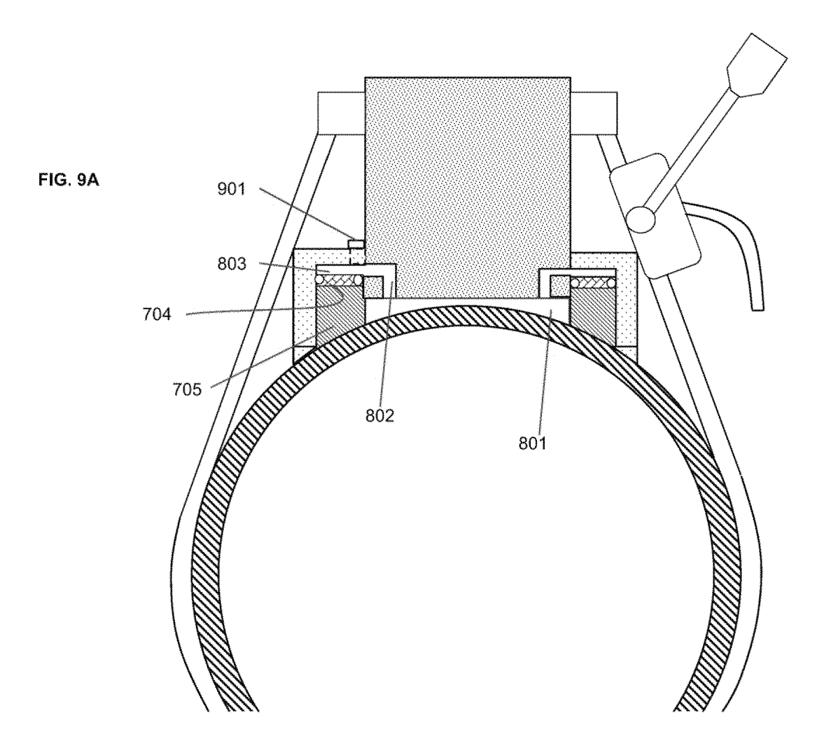

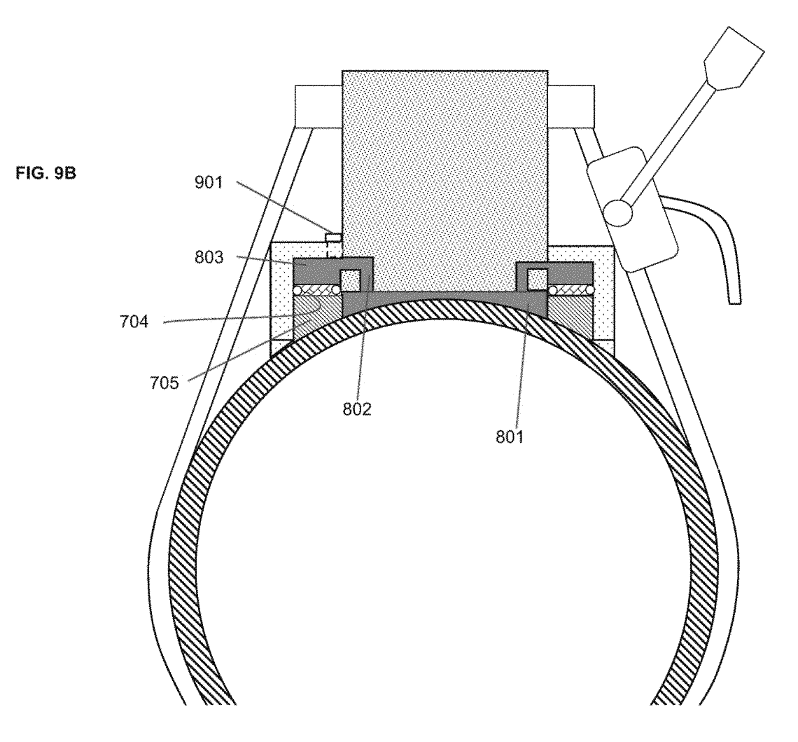

FIGS. 9A and 9B show an alternative example embodiment to the sealing mechanism in FIGS. 8A and 8B. Instead, as per FIGS. 9A and 9B, gel is inserted into an opening 901, which passes the gel first into the chamber 803, then the channel 802, and then into the space 801. FIG. 9A shows the uncompressed state and without the gel. FIG. 9B shows the compressed state, including the gel.

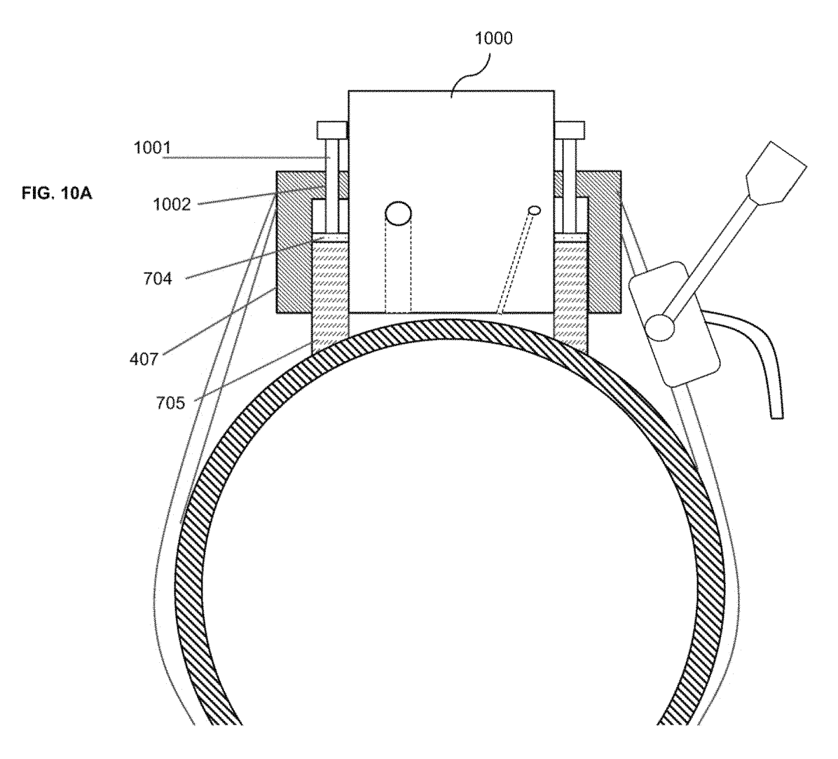

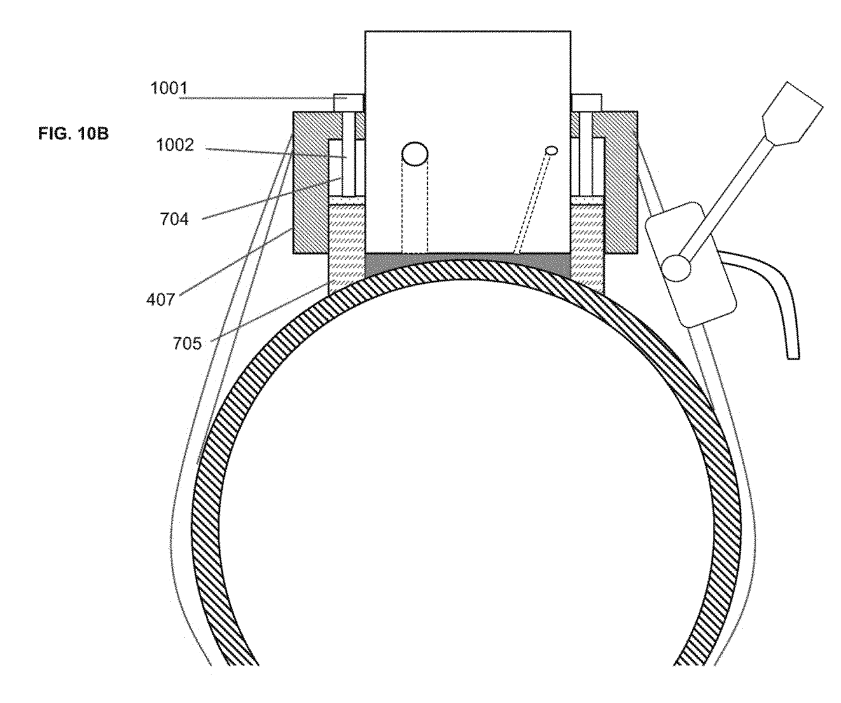

FIGS. 10A and 10B show another example embodiment of a sealing mechanism for a cleaning apparatus. At the top portion of the rigid seal cover 407, there are defined therein a number of threaded bolt holes 1002 through which a number of threaded bolts 1001 can pass through. The threaded bolts are screwed through the bolt holes and provide a downward force on to the annular plate 704. As shown in the compressed state in FIG. 10B, the seal 705 is compressed downwards as the plate 704 moves downwards. FIG. 10B also shows the gel filled within the cavity between the transducer and the tube. In an example embodiment there are three or more bolts that encircle the transducer 1000.

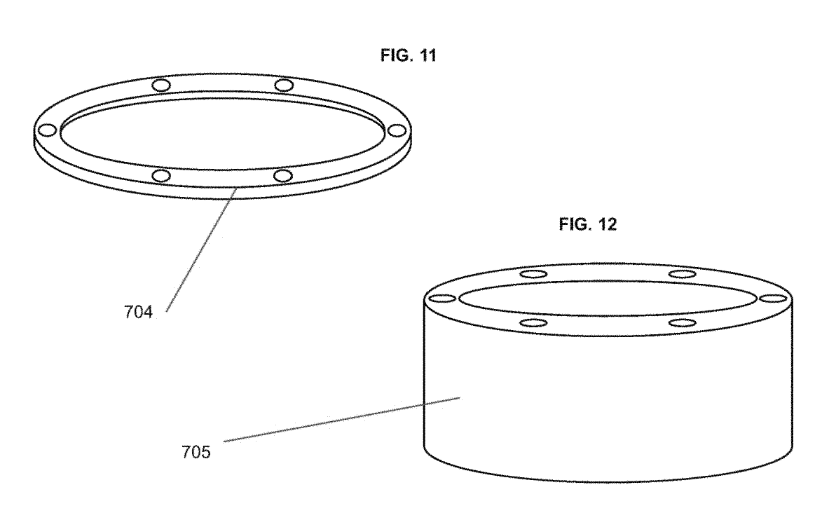

FIG. 11 shows the plate 704 in isolation. In an example embodiment, the plate is a rigid metal ring.

FIG. 12 shows an example of the seal 705 in isolation. In an example embodiment, it made of a rubber material or some other resilient and compressible material.

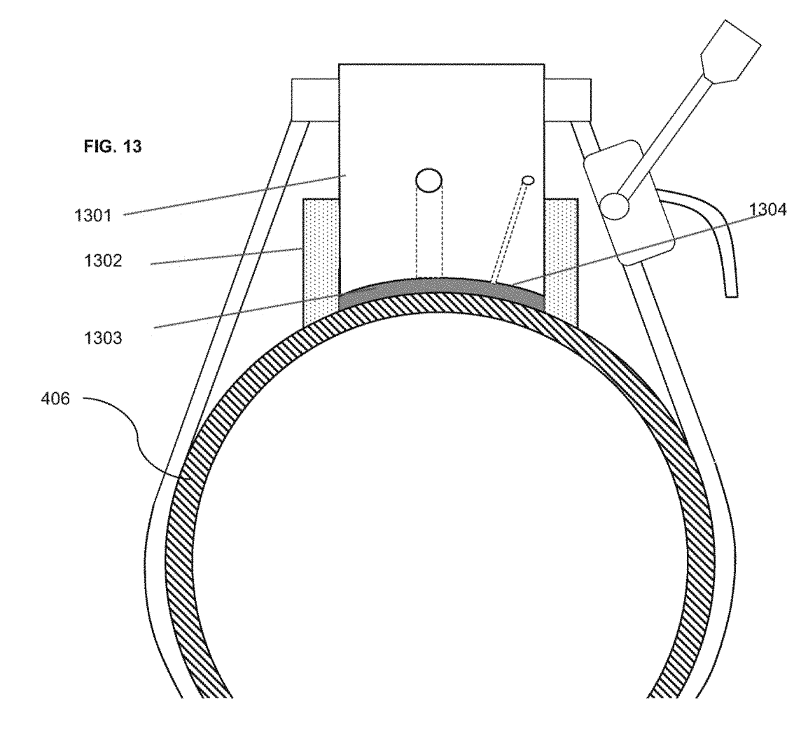

FIG. 13 shows another example embodiment of a cleaning apparatus, which includes a transducer 1301 with a bottom surface 1304 that is curved to match the outer radius of a tube 406. In an example embodiment, a sealing structure 1302 is positioned at the perimeter of the transducer 1301, in order to form a cavity that is fillable with gel 1303.

FIGS. 14A and 14B show another example embodiment of a sealing mechanism. As shown in FIG. 14A, the bottom of the transducer 1401 has a gel pouch 1402 that is fixed thereon. The pouch, for example, is plastic or other sheet material that is flexible and can transmit acoustic energy. The pouch holds gel. As shown in the compressed state in FIG. 14B, the gel pouch 1402 is compressed and conforms to the curvature of the tube. In this way, the cleaning apparatus is suitable for tubes of different diameters. Further, a gel is not required to be injected or placed onto the tube surface, as the gel is already positioned within the pouch.

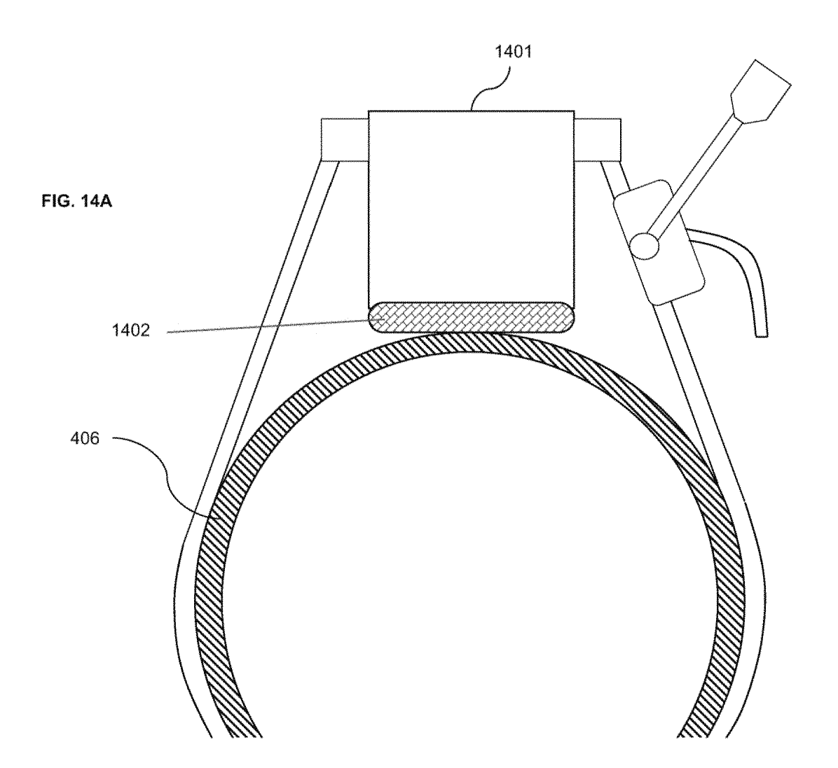

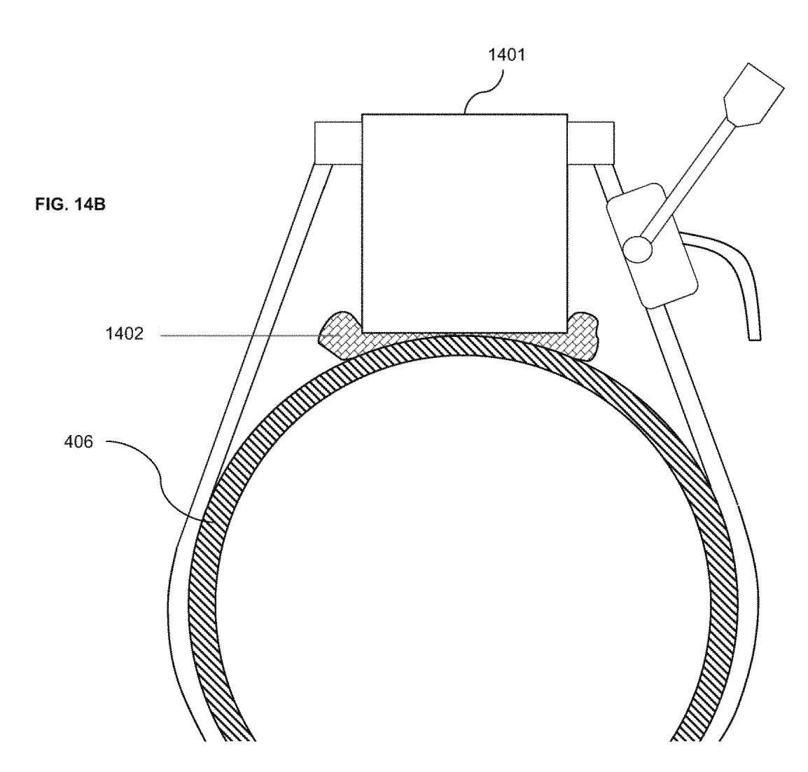

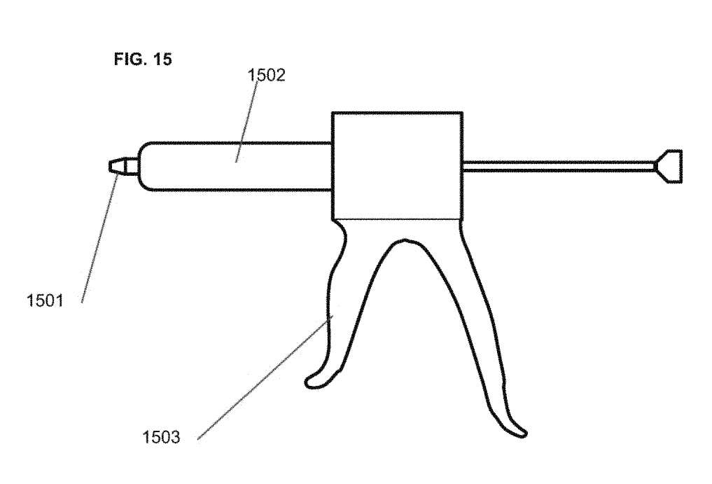

FIG. 15 shows an example gel injector or gel gun. It includes a nozzle 1501 that is sized to fit into the opening 503 of an injector hole 501. It also includes a barrel 1502 that stores the gel, and a trigger 1503 that pushes the gel out of the nozzle.

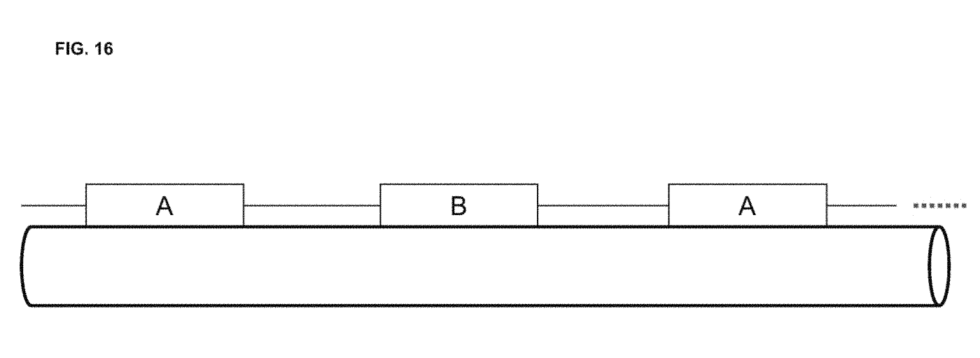

FIG. 16 shows alternating types of cleaning apparatuses fixed onto a tube. In an example embodiment, the “A” cleaning apparatus represents ultrasonic transducers and the “B” cleaning apparatus represents the sonic transducers.

In another example embodiment, the “A” cleaning apparatus represents an ultrasonic transducer that is affixed to the tube with a gel interface, and the “B” cleaning apparatus represents on with an ultrasonic transducer that is affixed to the tube without a gel interface. The “B” cleaning apparatus is configured to cause a larger portion of the tube to be excited with the acoustic energy.

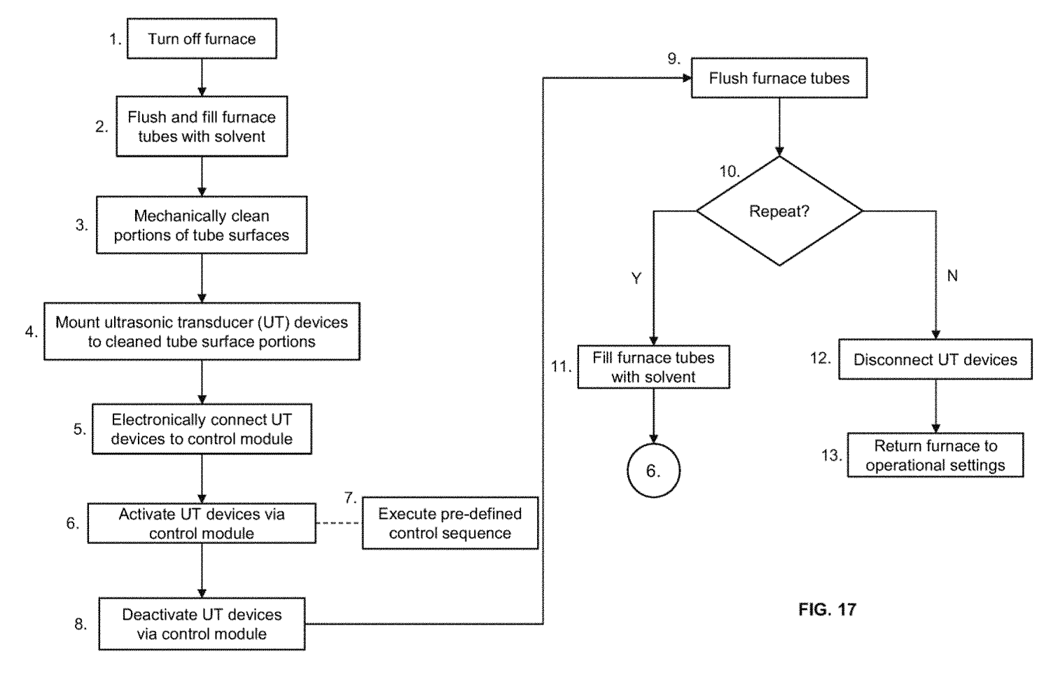

Turning to FIG. 17, an example embodiment of a cleaning process is provided.

At block 1, the furnace is turned off. At block 2, tubes are flushed are filled with a liquid, such as, but not necessarily, a cleaning solvent. At block 3, a user mechanically cleans portions of the tube surfaces at which multiple cleaning apparatuses will be placed. For example, a user may use a wire brush to clean an outer surface of the tube.

At block 4, the user mounts a cleaning apparatus to each of the cleaned surface portions. This may include using the clamping mechanism of the cleaning apparatus and injecting gel into the cleaning apparatus to ensure there is a seal.

At block 5, the user electronically connects each of the cleaning apparatuses together in a series, and connects the series to a primary control module. At block 6, the cleaning apparatuses are activated via the primary control module. For example, the primary control module activates the series of the cleaning apparatuses according to a pre-defined sequence (block 7). While being activated, cavitation of the liquid within the tubing causes the scaling and build-up of material to be dislodged.

At block 8, the series of the ultrasonic transducers are deactivated by the primary control module. At block 9, the liquid within the tubing is flushed.

If the process is repeated at least one or more times, as per block 10, then at block 11, the liquid inside the tubing is flushed out and then refilled with new liquid. The process repeats by returning to block 6. It will be appreciated that the cleaning process may repeat multiple times.

If the process is not to be repeated, then the user disconnects the cleaning apparatuses from each other and also removes the cleaning apparatuses (block 12). At block 13, the furnace is then returned to operational settings.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the primary control module 303, or a controller 201, or accessible or connectable thereto. Any application or module herein described may be implemented using computer readable/executable instructions that may be stored or otherwise held by such computer readable media.

In another aspect, it is herein recognized that it is also desirable to place a cleaning apparatus within the wall of the tube or directly within the flow of the tube, or both, in order to clean the inner surface of the tube.

It is also recognized that an ultrasonic transducer may be permanently placed within the flow of the tube. However, placing the ultrasonic transducer within the tube may disrupt the flow of the fluid within the tube, thereby reducing performance when the cracking furnace or other heat exchanger mechanism is in operation. It is also recognized that an ultrasonic transducer may degrade if placed within a cracking furnace due to the extreme heat. Therefore, it is herein recognized that it is also desirable to remove an ultrasonic transducer, or another type of sensitive cleaning apparatus, from a tube when the cracking furnace is in operation.

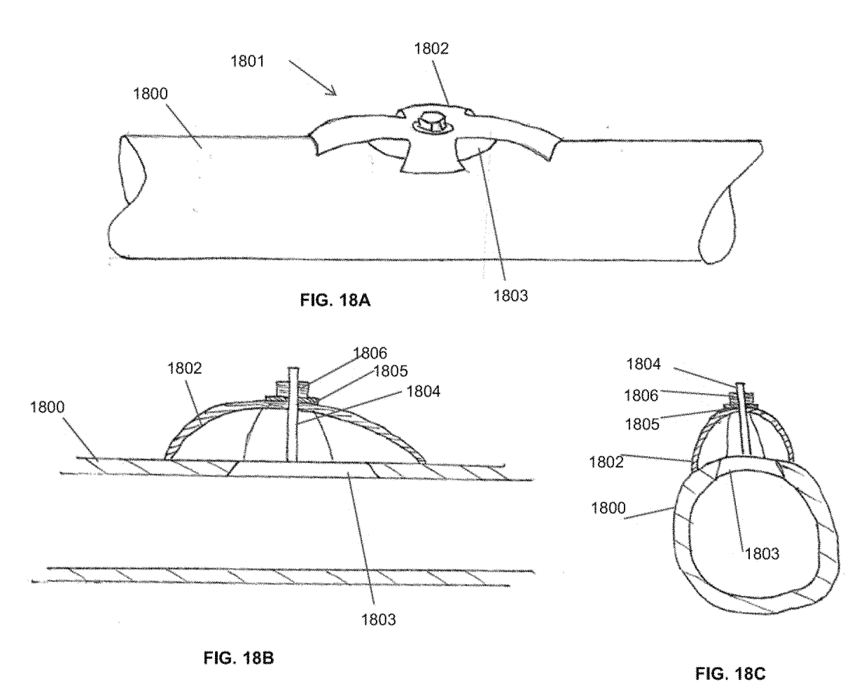

Turning to FIGS. 18A, 18B and 18C, different views of an example embodiment of a section of a tube 1800 that includes a removable plug 1801 to cover a hole defined in the wall of the tube. During normal operation of the tube in a cracking furnace or other heat exchanger, the plug 1801 is positioned in the hole and the fluid within the tube 1800 flows undisturbed.

As best seen in the cross-section views in FIGS. 18B and 18C, the opening of the hole at the interior of the tube is larger than the opening of the hole at the exterior of the tube. In other words, the hole tapers to smaller opening at the exterior of the tube. This tapered surface in the tube (i.e. extending from the interior surface of the tube to the exterior surface of the tube) is a mechanical receiver that receives a plug 1801. The plug 1801 includes a tapered plug 1803 sized to fit the hole and match the taper of the tapered surface. A threaded shaft or pin 1804 is fixed to the top of the tapered plug 1803 and extends therefrom. The pin 1804 passes through a hole of a clamp 1802. A washer 1805 and a threaded nut 1806 are positioned over the clamp 1802 to lock the clamp 1802 and the tapered plug 1803 in place. In particular, the nut interacts with the threaded pin 1804 to cause the clamp 1802 to push downwards onto the tube 1800. The nut also interacts with the threaded pin 1804 to pull the tapered plug 1803 upwards. As best seen in FIG. 18C, the plug 1803 has a curved surface to match the inner radius of the pipe 1800, in order to facilitate laminar flow. In a preferred example embodiment, the plug 1801 is configured to withstand the same or similar environmental and operating conditions (e.g. temperature and pressure) as the tube 1800.

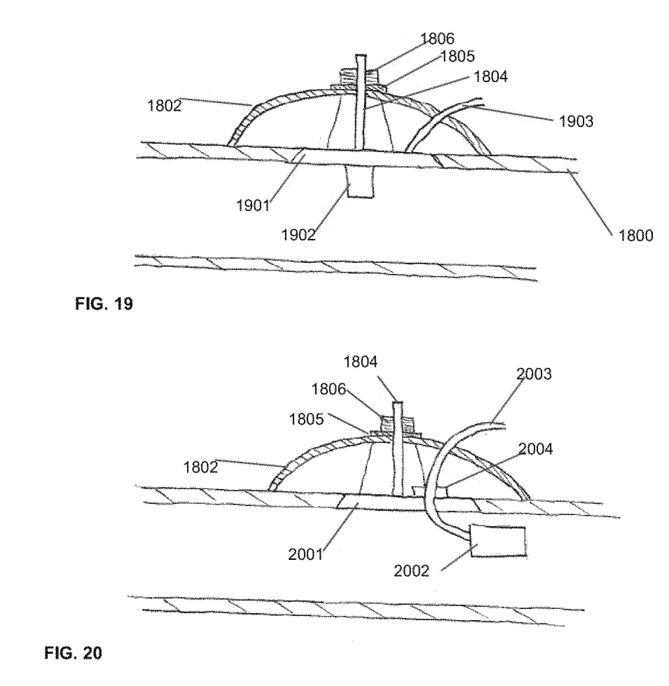

The plug 1801 is removable and can be switched with an ultrasonic transducer, or other cleaning apparatus, during cleaning operations. An example of this is shown in FIG. 19.

Turning to FIG. 19, a cleaning apparatus is positioned within the tapered plug 1901. For example, an ultrasonic transducer is positioned within the tapered plug 1901 and causes the tube wall 1800 to vibrate, thereby removing scaling and other unwanted build-up of material. A wire 1903 is attached to the exterior of the plug 1901 to provide electric power to the ultrasonic transducer. The threaded pin 1804 is fixed to the plug 1901 and the plug 1901 is secured using a similar mechanism as shown in FIGS. 18A, 18B and 18C.

In a further example embodiment, either in addition or in the alternative, an ultrasonic transducer 1902 extends from the plug 1901 into the tube cavity. The transducer 1902 excites the liquid within the tube 1800.

FIG. 20 shows the tube 1800 with the tapered opening. The plug 1801 is removed and, in its place, a cleaning apparatus is positioned. The cleaning apparatus includes a tapered plug 2001 with a wire 2003 strung through, and held in place with a seal 2004. At the end of the wire 2003, and positioned within the interior of the tube, are one or more ultrasonic transducers 2002. The one or more transducers 2002 excite the liquid within the tube.

It an example embodiment, there are multiple tapered holes with plugs 1801 along the length of the tube. During a cleaning operation, each of the plugs 1802 are removed and the cleaning apparatuses are attached instead. The wires 1903 or 2003 may be connected together, so as to power multiple cleaning apparatuses at the same time.

After the cleaning operations are complete, the cleaning apparatus is removed from the tube and the plug 1801 is put back into the hole of the tube for nominal operation.

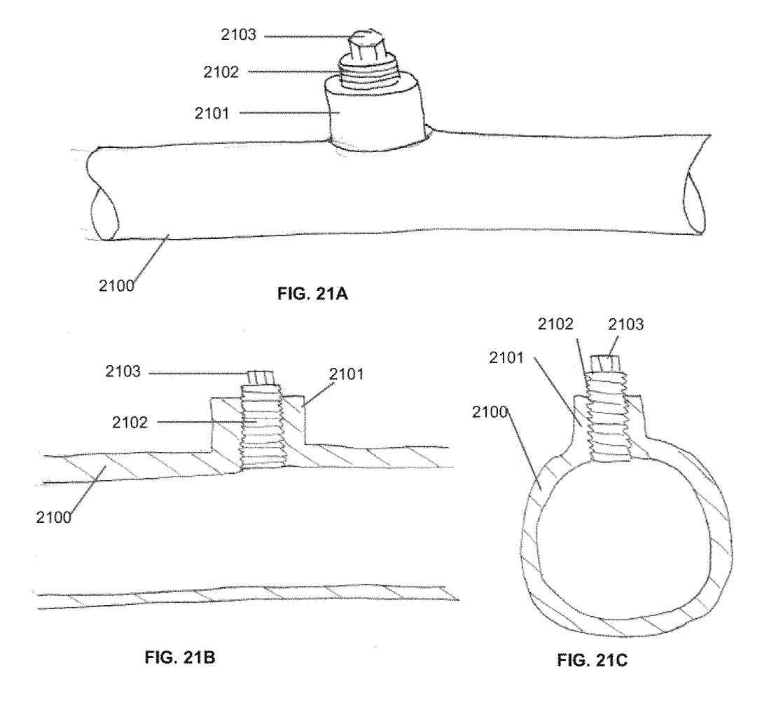

FIGS. 21A, 21B and 21C show another example embodiment of a section of a tube 2100 with flange 2101 that receives a plug 2102. The flange 2101 protrudes from the tube 2100 and includes an opening that is in fluidic communication with the interior of the tube. The inner wall of the flange is threaded and defines a cylindrical space. The plug 2102 is threaded and screws into the flange 2101. A bolt head 2103 is fixed to the top of the plug 2102, so that a tool may be used to easily turn the plug 2102. In a preferred example embodiment, the plug is configured to withstand the same or similar environmental and operating conditions (e.g. temperature and pressure) as the tube 2100. The plug 2102 is also configured to reduce or cause little disturbance to the flow of the liquid within the tube during normal operations. For example, the bottom of the plug is nearly flush with the inner surface of the tube.

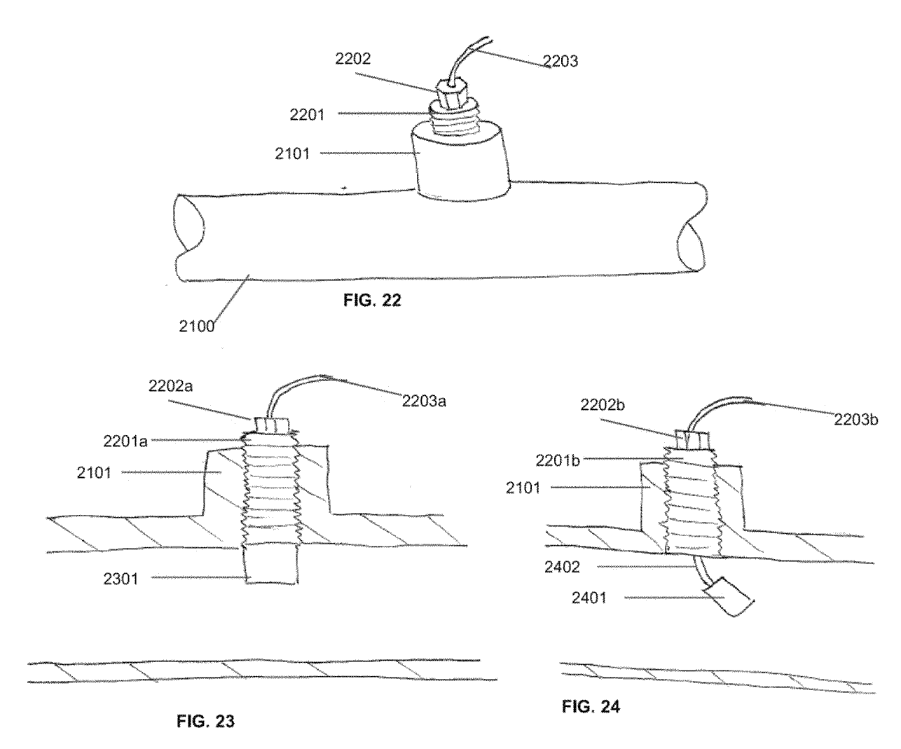

During a cleaning operation, the plug 2102 is removed from the tube 2100. As shown in FIG. 22, a cleaning apparatus of similar shape is put in place of the pug 2102. The cleaning apparatus also includes a threaded body 2201, a bolt head 2202 and a wire 2203 to supply electric power to the cleaning apparatus.

In other words, the cleaning apparatus includes an outer threaded surface, and the mechanical receiver (e.g. flange 2101) comprises an inner threaded surface, and the cleaning apparatus is configured to screw into the mechanical receiver.

Turning to FIG. 23, in an example embodiment of a cross-section taken from FIG. 22, one or more ultrasonic transducers are embedded within the threaded body 2201a in order to cause the tube wall 2100 to vibrate. The bolt head 2202a and the wire 2203a are also shown.

In another example embodiment, either in addition or in alternative to the above, one or more ultrasonic transducers 2301 are positioned below the threaded body 2201a. In other words, the one or more transducers 2301 are within the flow of the liquid in the tube, and are positioned to excite the liquid (e.g. to cause cavitation).

FIG. 24 shows the same section of tube and the same flange 2101, but with a different example embodiment of a cleaning apparatus. One end of the wire 2203b is connected to a top of the threaded body 2201b or the bolt head 2202b. Another end of a wire 2402 extends from the bottom of the threaded body 2201b and connects to another body 2401 containing one or more ultrasonic transducers. The body 2401 is configured to be positioned more centrally within the tube cavity.

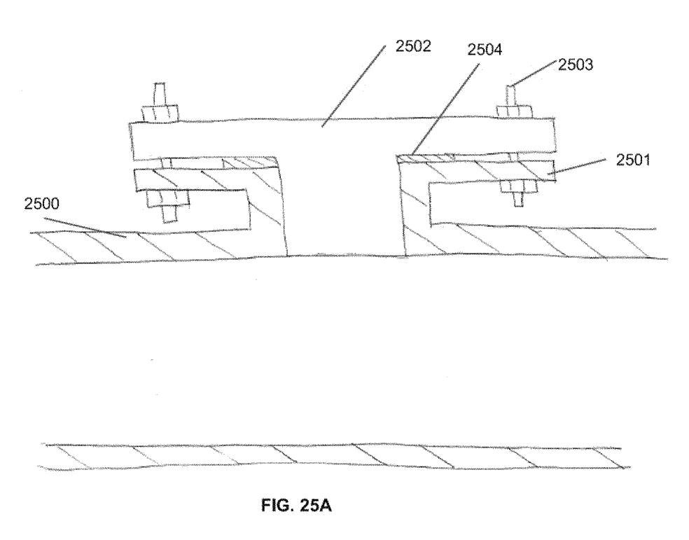

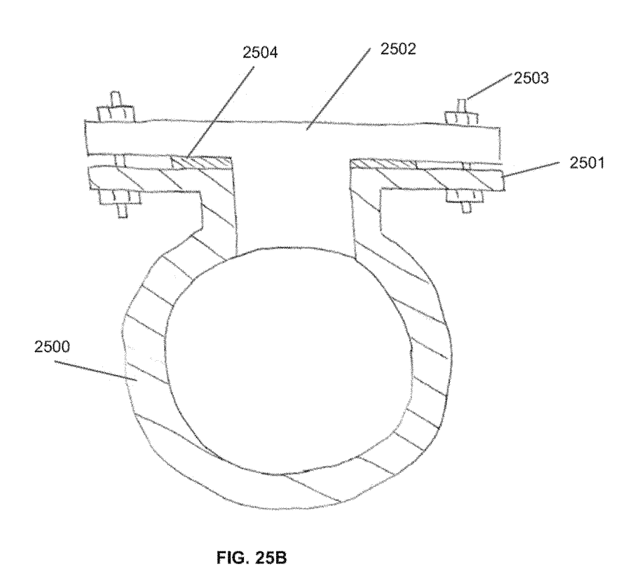

Turning to FIGS. 25A and 25B, a section of a tube 2500 includes a flange 2501 that extends out from the tube. The flange defines an opening that is in fluidic communication with the cavity of the tube. The flange includes a plate that has holes to hold a threaded pin 2503 or bolt. A removable plug 2502 is positioned within the flange and is held in place using the threaded pins 2503 or bolts, along with threaded nuts. A sealing gasket 2504 is positioned to between a plate of the plug 2502 and a plate of the flange 2501.

As best seen in FIG. 25B, the bottom of the plug 2502 has a curved surface to match the inner radius of the tube 2500, in order to facilitate laminar flow. In a preferred example embodiment, the plug 2502 is configured to withstand the same or similar environmental and operating conditions (e.g. temperature and pressure) as the tube 2500.

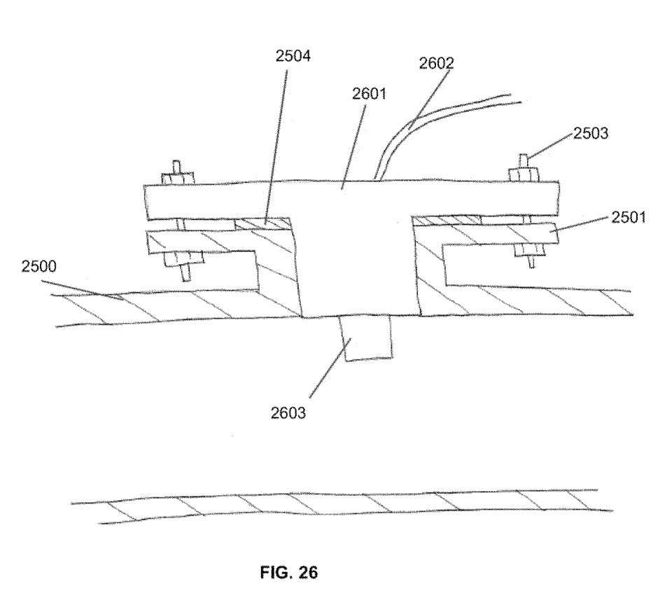

Turning to FIG. 26, the plug 2502 is removed and is replaced with a cleaning apparatus 2601. Within a main body of the cleaning apparatus 2601, there are one or more acoustic or ultrasonic transducers that cause the tube wall to vibrate. A wire 2602 is connected to the apparatus 2601 to provide electric power.

In another example, either in addition or in the alternative, a protruding body 2603 protrudes from the main body 2601. The protruding body 2603 includes one or more ultrasonic transducers to excite the liquid within the tube.

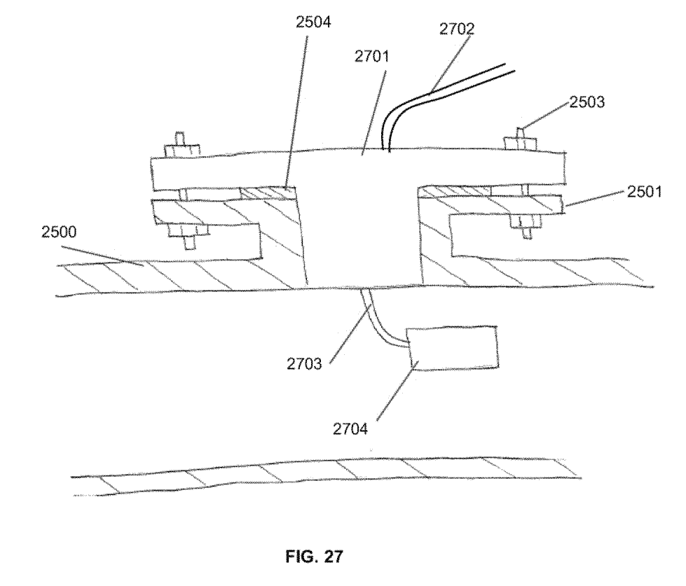

Turning to FIG. 27, in another example of a cleaning apparatus that interfaces the flange 2501, a main body 2701 is attached to one end of a wire 2702 to provide power to the one or more ultrasonic transducers in the secondary body 2704. The secondary body 2704 is attached by another end of a wire 2703 to the main body 2701.

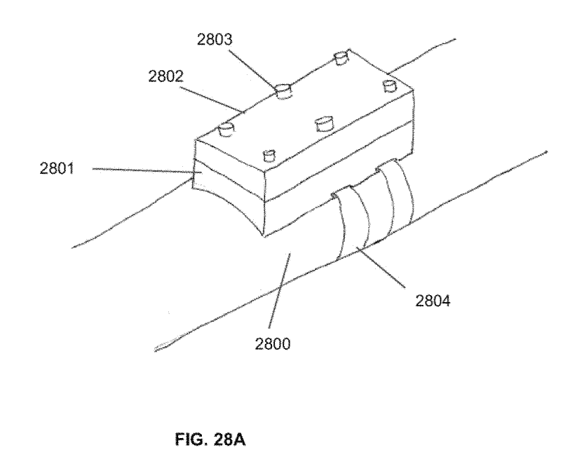

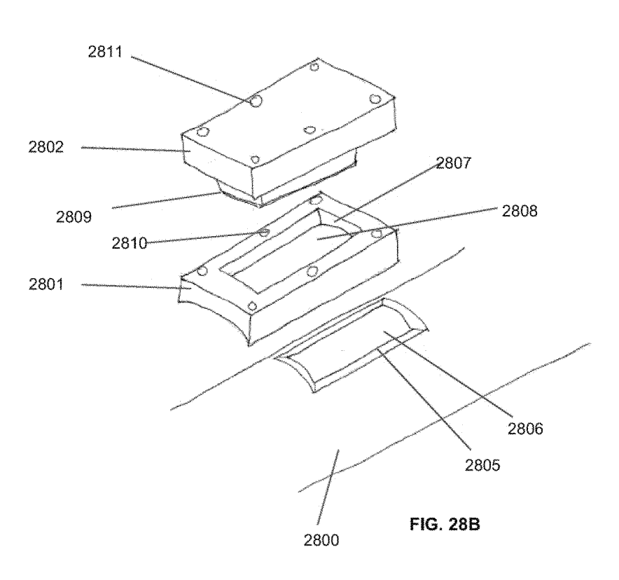

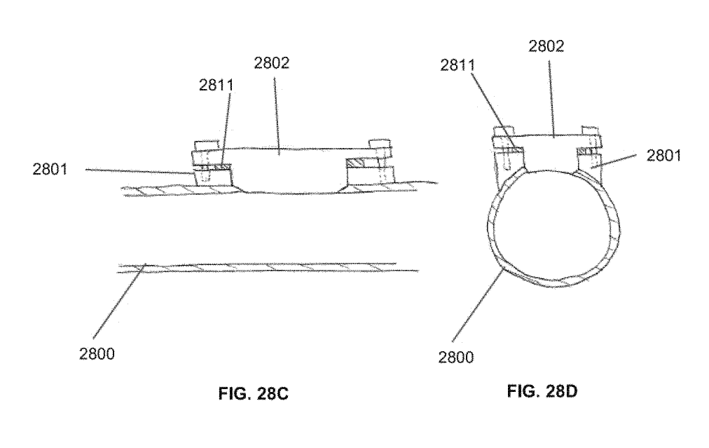

Turning to FIGS. 28A, 28B, 28C and 28D, a receiving flange 2801 is welded onto the tube 2800, or is strapped onto the tube with straps 2804. A plug 2802 is placed over the flange 2801 and secured thereto using bolts 2803.

As better seen in the exploded view of FIG. 28B, the tube 2800 includes a cut-out 2805 with tapered walls, which defines an opening 2806 in the tube 2800. The receiving flange 2801 includes interior walls 2807 that defines an opening 2808 that is to be aligned with the opening 2806. The flange 2801 also includes threaded holes 2810 to receive a bolt 2803. The plug 2802 includes a nested portion 2809 that passes into the opening 2808 and covers the opening 2806 of the tube.

In a preferred example, the bottom of the nested portion 2802 is curved to match the inner radius of, and to be flush with, the inner surface of the tube 2800. This is best shown in FIG. 28D. This reduces turbulence of liquid within the tube during normal operation. A sealing gasket 2811 is positioned between the receiving flange 2801 and the plug 2802.

In a preferred example embodiment, the plug 2802 is configured to withstand the same or similar environmental and operating conditions (e.g. temperature and pressure) as the tube 2800.

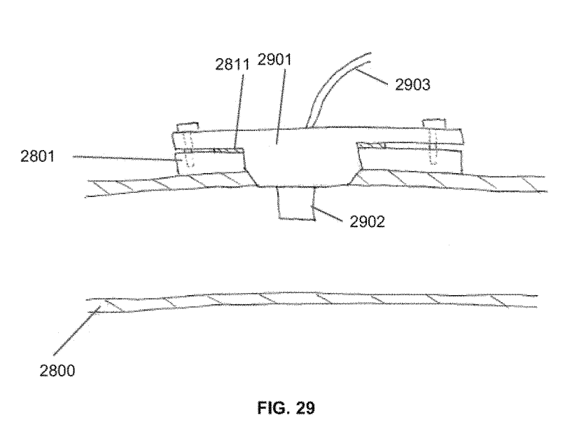

Turning to FIG. 29, the plug 2802 is removed and is replaced with a cleaning apparatus comprising a main body 2901 with a wire 2903 extending therefrom. The main body 2901 is shaped similar to the plug 2802 and is receivable and securable to the flange 2801.

One or more ultrasonic transducers are embedded within the main body 2901 and, when excited, can cause the walls of the tube 2800 to vibrate.

In another example, either in the alternative or in addition, a secondary body 2902 protrudes from the main body and into the flow of liquid in the tube. The secondary body includes one or more ultrasonic transducers and excites the liquid in the tube.

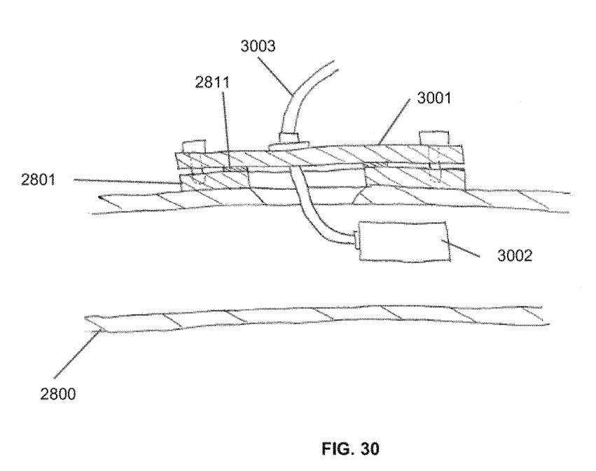

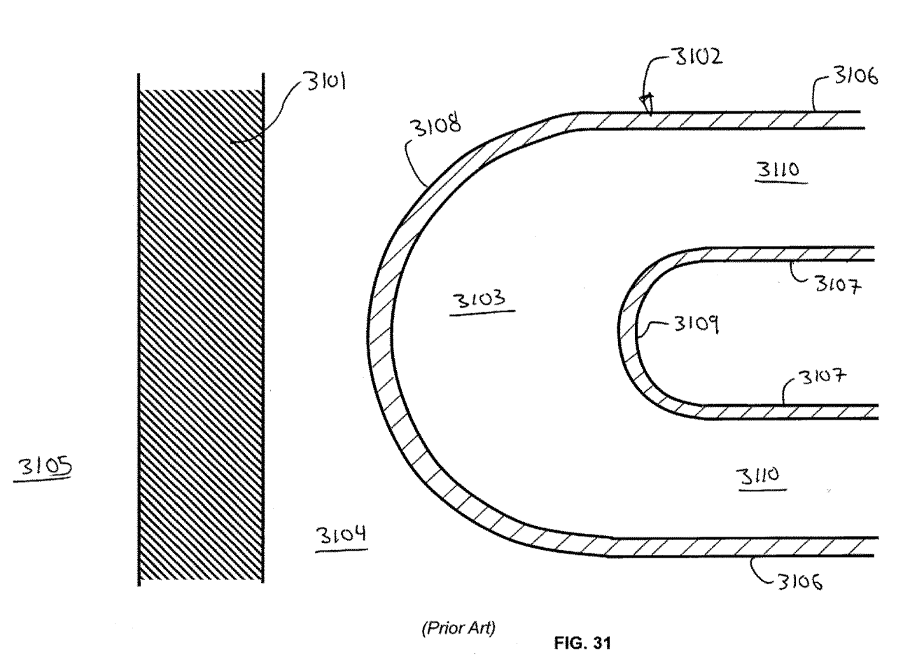

In another example embodiment, another configuration of a cleaning apparatus is attached to the receiving flange 2801 as shown in FIG. 30.

A cover plate 3001 is secured to the receiving flange 2801. A wire 3003 passes through a sealed opening in the cover plate. At the end of the wire is a body 3002 that is positioned within the cavity of the tube. The body 3002 contains one or more ultrasonic transducers for exciting the liquid within the tube. The wire 3003 provides electric power to the one or more transducers.

It will be appreciated that the above examples shown in FIGS. 18-30 generally include a tube that includes a mechanical receiver positioned at an opening in a wall of the tube. The mechanical receiver may be a flange that is part of a tube or mounted to a tube, or may be a tapered opening itself (as shown in FIGS. 18A-18C). A removable plug can be mechanically fastened and removed from the mechanical receiver. A cleaning apparatus can be mechanically fastened to the mechanical receiver in place of the removable plug, and can be subsequently removed from the mechanical receiver. The cleaning apparatus includes one or more electromechanical devices to at least one of vibrate the wall of the tube and excite liquid within the tube. A wire extends from the cleaning apparatus to provide electric power to the electromechanical device.

In another example embodiment, the cleaning apparatus is located on a bend portion of a tube.

In particular, turning to FIG. 31, an example of a portion of a furnace wall 3101 is shown, which separates an interior space 3104 from the exterior space 3105. Within the interior space 3104 of the furnace, there is tubing. In FIG. 31, a cross-sectional view of the tubing 3102 with a U bend is shown. Fluid passes through a straight passage 3110 defined within the tubing, then through a bend passage 3103 defined within the tubing, and then to another straight passage 3110 defined within the tubing. In particular, the bend includes an outer straight portion 3106 and an inner straight portion 3107 that respectively lead to an outer bend portion 3108 and an inner bend portion 3109. The outer bend portion 3108 and the inner bend portion 3109 then respectively lead to another outer straight portion 3106 and another inner straight portion 3107.

As can be seen in FIG. 31, the bend portion of the tubing is not accessible.

It will be appreciated that although an example orientation of the U bend is shown relative to the furnace wall 3101, other orientations are applicable.

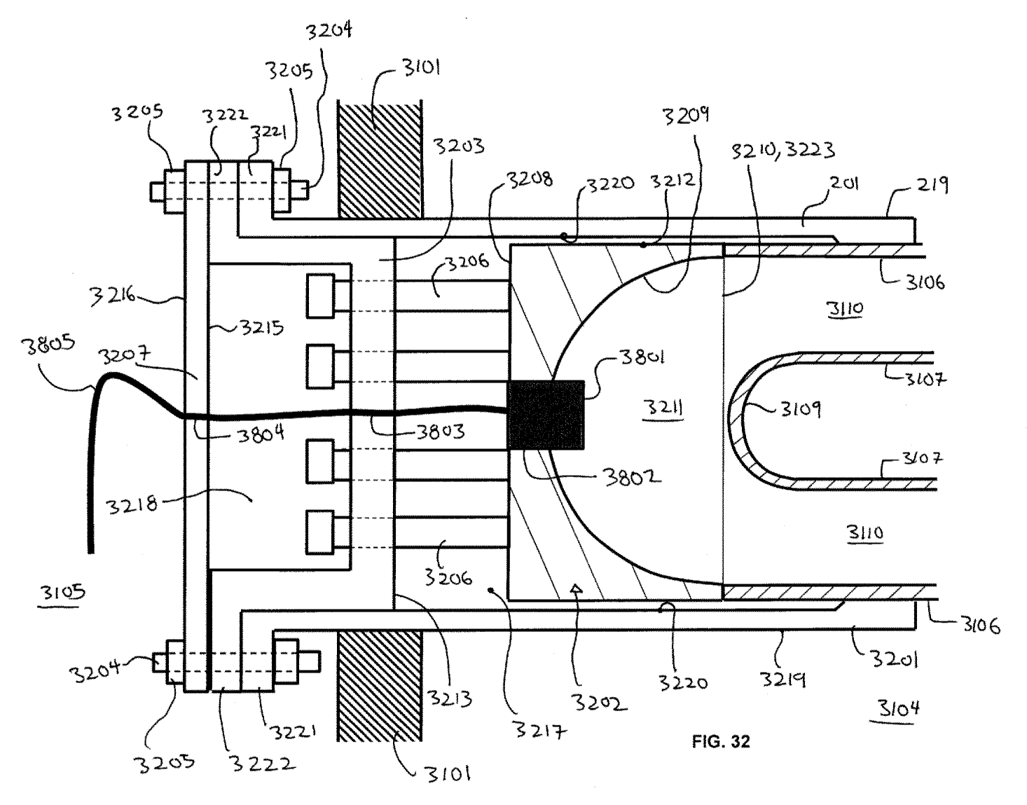

Turning to FIG. 32, an example embodiment of a removable bend portion, also called a bend cap, 3202 is shown braced against tubing portions 3106, 3107, 3109. These portions and the section of the furnace wall 3101 are shown in a cross-sectional view. A jacket 3201, also called a sleeve, is fixed to the two straight portions of the tubing, such as, but not limited to portion 3106. The jacket 3201 extends from within the interior space 3104 of the furnace, passes through the furnace wall 3101, and extends outwards into the exterior space 3105. The inner surface of the jacket 3220 is dimensioned to allow the removable bend cap 3202 to slide in and out of the jacket. In other words, there is some space between the inner surface 3220 of the jacket and the exterior side surface 3212 of the bend cap 3202. It is appreciated that the furnace wall is sealed to the outer surface 3219 of the jacket 3201, so that heat and other gases, fluids, liquids, vapors, etc. do not escape, from the interior of the furnace to the exterior space 3105, or that such escape is reduced to an appropriate level. There is also a seal between the jacket 3220 and the fixed section or sections of tubing, so that liquids, gases, vapors, plasma, or combinations thereof, do not escape. In an example embodiment, the seal between the jacket 3220 and the tubing is a seal weld, but other types of seals can be used.

A push mechanism is positioned within the jacket 3201 that exerts a pushing force against the exterior bracing surface 3208 of the removable bend cap 3202 to push a seating surface 3210 of the removable bend cap against an end surface 3223 of the two sections of the tubing. The example push mechanism in FIG. 32 is shown as jack screws 3206. However, other types of push mechanisms that exert a pushing force to push against the removable bend cap 3202 to seal with the tubing can be used. For example, other push mechanisms include hinged clamps, hydraulic pistons, pneumatic pistons, devices with threaded screws, or combinations thereof.

In particular, continuing with FIG. 32, the outer end of the jacket 3201 includes a flange 3221 that is positioned exterior to the furnace. A bracket 3213 having it owns flange 3222 is connected to the jacket's flange 3221, such as by bolts 3204 and nuts 3205. The bracket 3203, also called a jacking bracket, holds a number of jack screws 3206 which push against an exterior bracing surface 3208 of the removable bend cap 3202. A seating surface 3210 of the removable bend cap 3202 is pushed against the end surface 3223 of the tubing. The seating surface 3210 and the end surface 3223 of the tubing form a seal so that little or no fluid leaks from between these surfaces. The force of the jack screws 3206 help to create a stronger seal. In particular, the jack screws 3206 are turned to control the amount of force pushing against the exterior bracing surface 3208 of the removable bend cap 3202. In an example embodiment, a gasket or some other sealing material is positioned at or between the seating surface 3210 and the end surface 3223 to help improve the sealing properties. In another example embodiment, a gasket is not used.

It will be appreciated that the jacket 3201, the bracket 3203, and the blind flange 3207 are shown in a cross-sectional view, with the bracket 3203 nested within the jacket 3201.

The interior of the removable bend cap 3202 includes a rounded surface 3209 that defines an interior bend space 3211. Therefore, the straight passages 3110 are in fluidic communication with the interior bend space 3211, allowing the fluid to flow around the bend between different straight portions of tubing.

In the example of FIG. 32, the removable bend cap only includes the surface (e.g. rounded surface 3209) that defines the outer bend radius of a bend in a tube. The surface (e.g. inner bend portion 3109) that defines the inner bend radius is on the fixed section of the tubing. In this way, it is easier to access and, therefore, inspect and clean, the inner surfaces of the tubing at a bend.

The system also includes a blind flange 3207 that is braced against the flange 3222 of the jacking bracket 3214. In particular, the bolts 3204 hold together the blind flange 3207, the jacking bracket 3203 and the jacket 3201. Although bolts and nuts are shown, it will be appreciated that other clamping mechanisms or mechanical fasteners could be used.

The blind flange 3207 includes an exterior surface 3206 and an opposite interior surface 3215. The interior surface 3215 of the blind flange 3207 faces the exterior surface 3214 of the jacking bracket 3203, and these surfaces together define a space 3218 there-between.

Opposite to the exterior surface 3214 of the jacket bracket 3203 is the interior surface 3213 of the jacking bracket 3203. The bracing surface 3208 of the removable bend cap faces the interior surface 3213 of the jacking bracket 3203, and these surfaces, together with the interior surface 3229 of the jacket 3201 define another space 3217.

In an example embodiment, one of, or both of, the spaces 3217 and 3218 are filled with a thermal insulator material, such as a thermal insulator gas, liquid, vapor, or plasma. In an example embodiment, the thermal insulator is ethylene.

In another example embodiment, one of, or both of, the spaces 3217 and 3218 are filled with the same fluid that is passing through the tubing.

In another example embodiment, one of, or both of, the spaces 3217 and 3218 are filled with the same fluid that is within the furnace enclosure, but is exterior to the tubing.

In another example embodiment, the thermal insulator is at a higher pressure in spaces 3217 or 3218, or both, compared to the pressure within the tubing. In this way, if there is leakage between the tubing and the removable bend cap, the insulator leaks into the tubing. For example, the insulator is a desirable product of a cracking process, such as ethylene, propylene, butadiene or some other hydrocarbon.

To remove the removable bend cap, the blind flange 3207 is first removed. The jacking bracket 3203 is then removed, which provides access to the removable bend cap 3202. After the jacking bracket is removed, the removable bend cap 3202 is removed. The removable bend cap can then be inspected or cleaned, or both. Similarly, the tubing portions 3106, 3107, 3109 can also be inspected or cleaned, or both.

In this way, personnel can access the bend portion of the tubing from outside of the furnace (e.g. at the exterior space 105), as well as to remove the removable bend cap 202 for inspection and cleaning while being outside the furnace. This is very convenient as it saves time. In particular, personnel do not need to wait for the furnace to cool down to enter the interior of the furnace.

The removable bend cap 3202 includes an aperture 3802 that holds a cleaning apparatus device 3801. In an example embodiment, a portion of the cleaning apparatus 3801 is in direct contact with the removable bend cap and another portion is contact with the fluid that fills the tubing.

For example, a liquid fills the tubing and the liquid and the cleaning apparatus are in contact with each other. The cleaning apparatus then emits energy, which is transmitted through the liquid, to clean the inner surfaces of the tubing.

A passage 3803 is defined in the jacking plate and a passage 3804 is defined in the blind flange to allow a wire 3805 to pass through, to connect to the cleaning apparatus 3801. For example, the wire supplies electrical power to the cleaning device.

In another example embodiment, the cleaning apparatus 3801 is battery powered, so that the wire 3805 is not required.

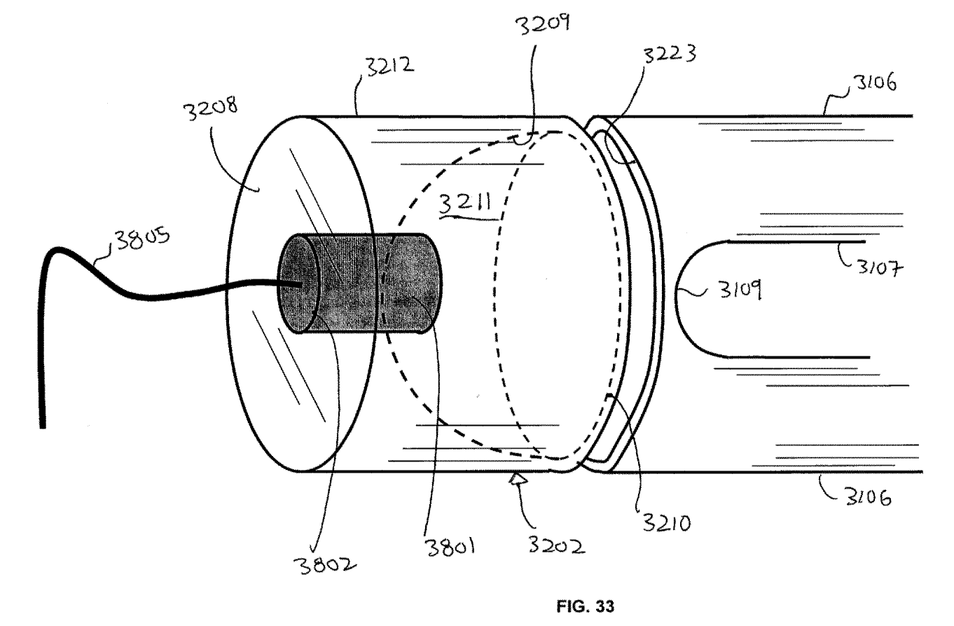

As shown in FIG. 33, an example embodiment of the removable bend cap 3202 is in spaced relation to the fixed tubing section, comprising tubing portions 3106, 3107 and 3109. As can be better seen in this embodiment, the bend cap 3202 can be oblong in shape and have a rounded surface 3209 that defines a bend space 3211. The bend space is like an ovoid and, in the example shown, the cleaning apparatus 3801 partially juts into the ovoid. In other examples, the cleaning apparatus 3801 is flush with the surface 3209. The jacket 3201 and the furnace wall 3101, as well as other components, are purposely not shown in this figure, in order to better show an example of the removable bend cap and the tubing portions.

It will be appreciated that the wires described above may also include control signals that control the operation of the one or more electromechanical devices. In an example embodiment, the electromechanical devices are ultrasonic transducers.

It will also be appreciated that other types of energy activated cleaning apparatuses may be used in addition to, in alternative to, ultrasonic transducers. Other types include mechanical vibration devices, electromechanical vibration devices, light sources (e.g. UV light or other light), heating elements, vibratory transducers (e.g. piezoelectric elements), and other types of acoustic transducers.

It will be appreciated that different features of the example embodiments of the system, the method and the apparatus, as described herein, may be combined with each other in different ways. In other words, different modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A cleaning system for cleaning tubes, the system comprising:
a string of multiple cleaning apparatuses in electrical communication with each other and configured to be mounted along a length of a tube;
a primary control module that is in electrical connection with a first cleaning apparatus in the string of multiple cleaning apparatuses; and
each one of the cleaning apparatuses comprising an acoustic transducer, a releasable clamping mechanism to mount the transducer to the tube and an electronic device to control the transducer;
wherein the electronic device is configured to receive a data command from the primary control module.

2. The cleaning system of claim 1 wherein the electronic device comprises a microcontroller.

3. The cleaning system of claim 1 wherein a given one of the cleaning apparatuses is attachable to an exterior surface of the tube.

4. The cleaning system of claim 1 wherein the tube includes a receiver, and at least a given one of the cleaning apparatuses is inserted into the receiver.

5. The cleaning system of claim 4 wherein the receiver is positioned at an opening defined in the wall of the tube.

6. The cleaning system of claim 5 wherein the at least one given cleaning apparatus is positioned within the opening and is in contact with fluid within the tube.

7. The cleaning system of claim 1 wherein each of the cleaning apparatuses includes one or more ultrasonic transducers.

8. The cleaning system of claim 1 wherein at least a portion of the cleaning apparatuses each include a sonic transducer, and another portion of the cleaning apparatuses each include an ultrasonic transducer.

9. The cleaning system of claim 1 wherein one or more of the cleaning apparatuses further includes a electromechanical device that produces vibrations.

10. The cleaning system of claim 1 wherein one or more of the cleaning apparatuses further includes a heating element.

11. The cleaning system of claim 1 wherein one or more of the cleaning apparatuses further includes an ultraviolet light source.

12. A method for cleaning a tube in a furnace, the method comprising:
filling the tube in the furnace with a liquid;
mechanically cleaning multiple portions an exterior surface of the tube, the multiple portions space apart from each other along a length of the tube;
activating the cleaning apparatuses via a primary control module that is in electrical communication with the cleaning apparatuses;
deactivating the cleaning apparatuses;
flushing the tube with new liquid; and
removing the cleaning apparatuses from the tube.

13. An acoustic energy cleaning apparatus for cleaning an interior surface of a tube, the apparatus comprising:
a transducer housing that houses an acoustic transducer;
a rigid seal cover that encompasses a lower portion of the transducer housing;
an annular resilient seal positioned within and below the seal cover;
an injection hole that fluidly connects a space, defined at least by the annular resilient seal and a bottom surface of the acoustic transducer, to an external environment, the injection hole having an opening to receive an injection of gel; and
a clamp to mount the transducer housing to the tube.

14. The acoustic energy cleaning apparatus of claim 13 wherein the acoustic transducer is an ultrasonic transducer.

15. The acoustic energy cleaning apparatus of claim 13 wherein the acoustic transducer comprises an ultrasonic transducer and a sonic transducer.

16. The acoustic energy cleaning apparatus of claim 13 further comprising a strap that is positioned around the tube, and the clamp tightens the strap.

17. The acoustic energy cleaning apparatus of claim 16, wherein the strap feeds through a ratchet clamp mechanism that is controlled by a ratchet lever.

18. A cleaning system for a tube, comprising:
the tube comprising a mechanical receiver positioned at an opening in a wall of the tube;
a removable plug that is mechanically fastenable and removable from the mechanical receiver;
a cleaning apparatus that is mechanically fastenable to the mechanical receiver in place of the removable plug, and is subsequently removable from the mechanical receiver;
the cleaning apparatus comprising an electromechanical device to at least one of vibrate the wall of the tube and excite liquid within the tube; and
a wire extending from the cleaning apparatus to provide electric power to the electromechanical device.

19. The cleaning system of claim 18 wherein the cleaning apparatus comprises an outer threaded surface, and the mechanical receiver comprises an inner threaded surface, and the cleaning apparatus is configured to screw into the mechanical receiver.

20. The cleaning system of claim 18 wherein the mechanical receiver is a tapered surface defining an opening at an interior of the tube that is larger than an opening at an exterior of the tube; and
the cleaning system further comprising a tapered plug that is tapered to match the taper of the tapered surface, and the cleaning apparatus is positioned within the tapered plug or the tapered plug holds the wire that extends to the cleaning apparatus.
